(19) United States
(12) Patent Application Publication
(10) Pub. No.: US 2024/0098514 A1
(43) Pub. Date: Mar. 21, 2024

(54) FINGERPRINT-BASED vRAN CELL INTEGRITY MONITORING

(71) Applicant: Intel Corporation, Santa Clara, CA (US)

(72) Inventors: Stephen T. Palermo, Chandler, AZ (US); Valerie J. Parker, Portland, OR (US); Vishal Gupta, San Diego, CA (US); Patrick L. Connor, Beaverton, OR (US); Kevin W. Bross, Tigard, OR (US)

(21) Appl. No.: 18/514,418

(22) Filed: Nov. 20, 2023

Related U.S. Application Data
(60) Provisional application No. 63/539,976, filed on Sep. 22, 2023.

(51) Int. Cl. H04W 16/18; H04L 5/00; H04W 40/22

(52) U.S. Cl. CPC H04W 16/18; H04L 5/0048; H04W 40/22

(57) ABSTRACT

Various approaches for the deployment and coordination of network operation processing, compute processing, and communications for 5G networks, including with the use of fingerprint-based vRAN cell integrity monitoring, are discussed. In an example, analyzing a state of a 5G network includes: obtaining initial fingerprint reference data of a network state between a virtualized radio access network (vRAN) node and at least one fingerprint reference unit (FRU) device wirelessly connected to the vRAN node; comparing the initial fingerprint reference data to subsequent fingerprint data of the network state between the vRAN node (e.g., operating as vRAN gNB, or as an IAB Donor or IAB Node) and the at least one FRU device to detect a changed network condition; and performing an action at the vRAN node to modify or disable a component of the 5G network, in response to detection of the changed network condition.

### PRIORITY CLAIM

This application claims the benefit of priority to U.S. Provisional Patent Application No. 63/539,976, filed Sep. 22, 2023, and titled “FINGERPRINT-BASED vRAN CELL INTEGRITY MONITORING”, which is incorporated herein by reference in its entirety.

### BACKGROUND

Various approaches are being investigated for new deployments and capabilities of 5G New Radio (5G NR) networks. 5G promises network densification, and 5G NR includes more bands than previous wireless network standards to transmit data. However, higher bandwidth (especially mmWave) propagation causes higher path loss, so more 5G deployments have led to the need for more Base Stations (BS) operating as gNBs. A BS is connected to the 5G core network (CN), such as through a wired or fiber connection; however, not all BSs can be reached with wired or fiber connections because of location and trenching costs, or because the BSs will be located in remote or temporary areas.

Based on these and other real-world constraints, the 3rd Generation Partnership Project (3GPP) has proposed the use of wireless Integrated Access Backhaul (JAB) via nodes that use wireless backhaul instead of fiber. Some implementations of IAB, for example, use the same access frequencies (e.g., FR1/FR2 frequencies) for wireless backhaul to connect BSs. 3GPP, in Release 18, has also introduced the concept of mobile integrated access and backhaul (mIAB) nodes, to enable the use of IAB nodes on-demand at mobile locations.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 provides an overview of network connectivity using IAB nodes and donors, according to an example;

FIGS. 2A and 2B depict network architectures corresponding to the use of IAB nodes and donors, according to examples;

FIG. 3 depicts a flowchart for an evaluation of IQ fingerprint data, according to an example;

FIG. 4 depicts a data processing workflow for an analysis of IQ fingerprint data, according to an example;

FIGS. 5A to 5F depict flowcharts of further approaches for an analysis of IQ fingerprint data, according to an example;

FIGS. 6A, 6B, and 6C illustrate respective and combined measurements of IQ fingerprint data from multiple antennas, according to examples;

FIG. 7 depicts a flowchart of an artificial intelligence (AI) training and inference workflow for Fingerprint Reference Unit (FRU) measurement collection, according to an example;

FIG. 8 depicts a flowchart of a method for implementing and operating a virtualized radio access network (vRAN) with analysis of IQ fingerprint data, according to an example;

FIGS. 9A, 9B, and 9C depict additional architectures for supporting vRAN and IAB configurations, according to examples;

FIG. 10 illustrates an overview of an edge cloud configuration for edge computing, according to an example;

FIG. 11 illustrates an overview of layers of distributed compute deployed among an edge computing system, according to an example;

FIG. 12 illustrates operational layers among endpoints, an edge cloud, and cloud computing environments;

FIG. 13 illustrates an example approach for networking and services in an edge computing system;

FIG. 14A illustrates an overview of example components deployed at a compute node system, according to an example;

FIG. 14B illustrates a further overview of example components within a computing device, according to an example; and

FIG. 15 illustrates a software distribution platform to distribute software instructions and derivatives, according to an example.

### DETAILED DESCRIPTION

The following addresses technical challenges encountered with 5G New Radio (5G NR) communications technologies. The following also provides approaches for maintaining and monitoring critical 5G NR communications, especially in Private 5G network cells that are extended temporarily. Among other settings, Private 5G network cells may be temporarily deployed to increase network capacity, including in emergency, disaster, or rapid deployment settings, at sports arenas, large cities, or at large-scale public events, or in connection with other situations that necessitate extra capacity or mobility.

These techniques for monitoring network infrastructure and 5G NR systems are applicable to a variety of 5G network settings and use cases. These use cases include user equipment (UE) connected to self-backhauling wireless Base Stations (e.g., IAB-Nodes) and temporary virtualized radio access network (vRAN) extensions. These use cases also include networks that perform communications using mmWave band self-backhauling IAB-Nodes, where the higher frequency transmission rates are challenged due to a short propagation lengths and path loss susceptibility.

The following introduces the use of a Fingerprint Reference Unit (FRU) device, which is a UE device configured to capture and monitor communication signals performed with a BS operating a vRAN system. For example, an FRU device may capture unique signatures of reference signal response IQ data samples, and monitor these data samples for changes that exceed predetermined limits at a specific periodicity. An FRU IQ data fingerprint may be captured and later compared to real-time periodic changes within the coverage area, as the network performs continuous monitoring (transposing) of fingerprint changes. Changes to the data fingerprint can be detected, and can be followed by actions or attempted actions at the BS and the vRAN to remediate situations that are deemed unacceptable.

The techniques discussed herein are thus directed at maintaining the integrity and reliability of a network, including in a variety of settings where IAB-Nodes or temporary vRAN nodes (fixed or mobile) are set up and deployed. The following text provides additional context on the type of network configurations and data that can be monitored, including but not limited to the use of IAB deployments. This is followed by an identification of what types of rules and operations (including artificial intelligence (AI) operations) may be used to detect abnormal conditions, and what types of changes may be deployed in a 5G network. A detailed discussion of these actions and capabilities is provided after an introduction of IAB networking and connectivity.

Overview of Integrated Access Backhaul

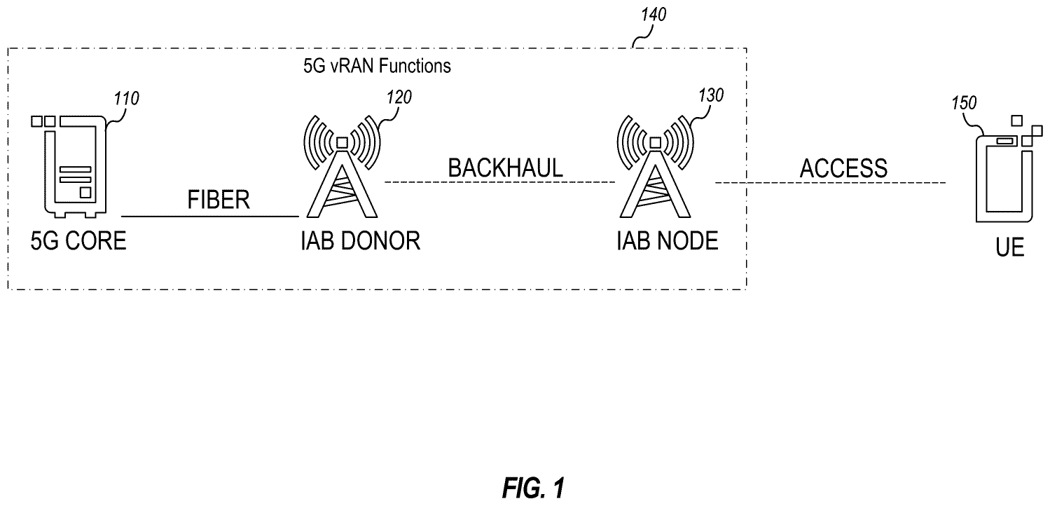

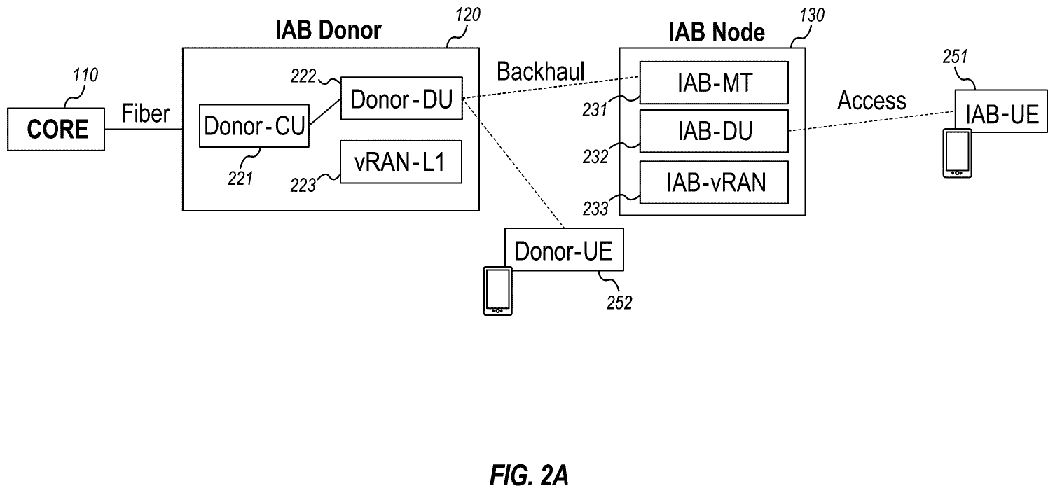

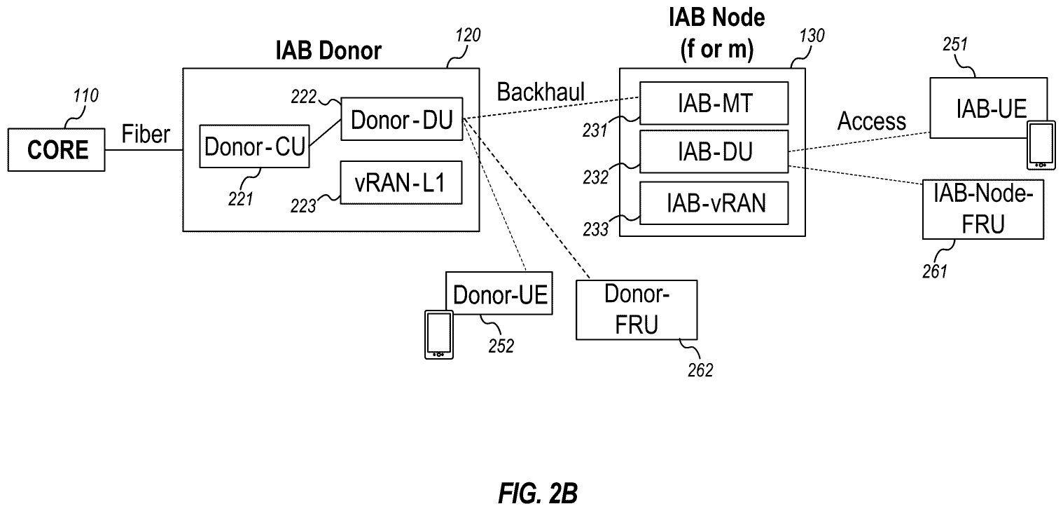

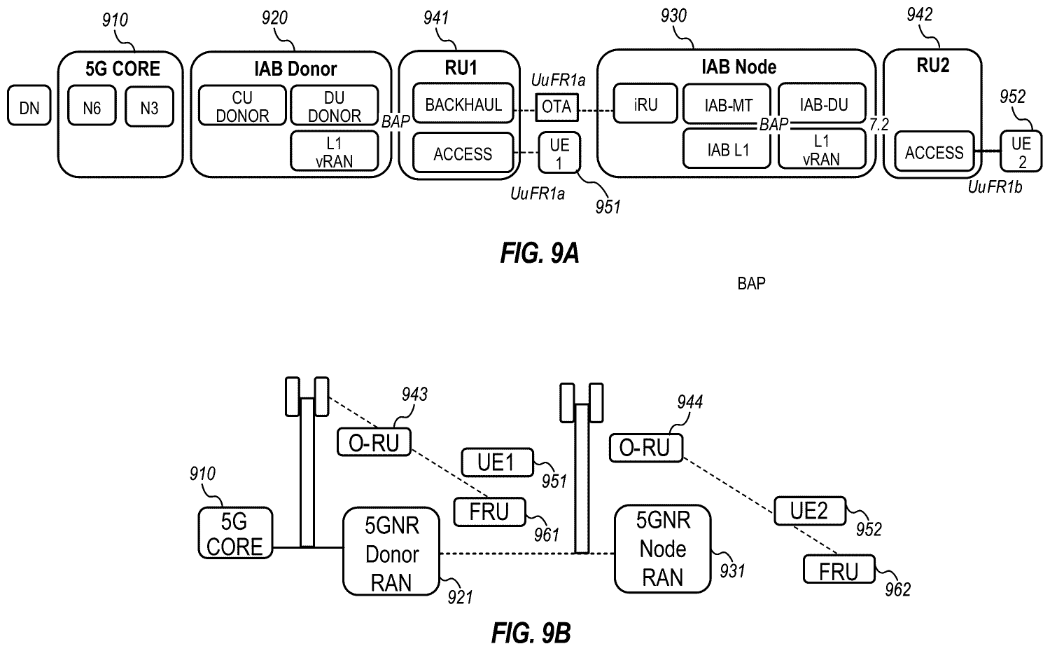

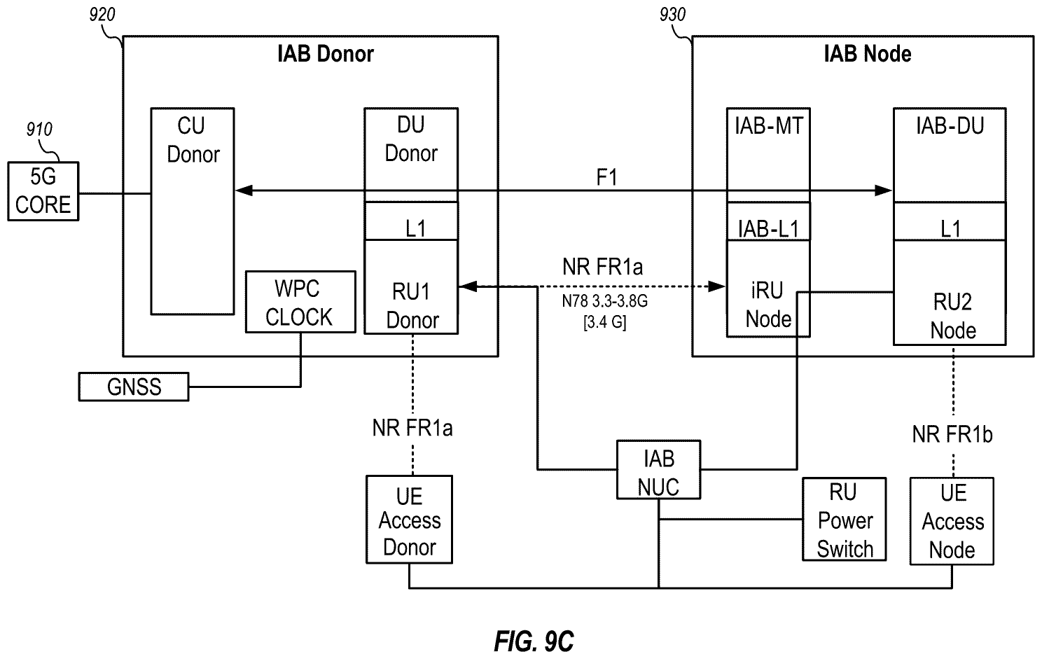

FIG. 1 provides an overview of network connectivity using IAB nodes and donors. FIG. 1 shows how a 5G Core 110 may utilize a wired link (e.g., fiber or copper network) to a IAB Donor 120, whereas the IAB Donor 120 uses a wireless backhaul to an IAB Node 130. This IAB Node 130 may be deployed at any number of locations or settings, to directly or indirectly provide access to a UE 150 (and other UEs not shown). A 5G virtualized radio access network (vRAN) is provided using vRAN functions 140 distributed among the 5G Core 110, the IAB Donor 120, and the IAB Node 130. The 5G Core 110, IAB Donor 120, and IAB Node 130 include respective hardware platforms and components (not depicted) for the execution of vRAN functions 140 that operate Layer 1 (L1), Layer 2 (L2), and/or Layer 3 (L3) layers via a software-based RAN stack. Additional detail on the configuration of a centralized unit (CU) and distributed unit (DU) in a vRAN is depicted with reference to FIGS. 2A to 2B, and FIGS. 9A to 9C, discussed below.

FIG. 2A depicts an architecture corresponding to the use of IAB nodes and donors. In an example, the IAB Donor 120 has a O-RAN 7.2 functional split using a CU for higher protocol tasks (e.g., authentication, etc.). The CU (e.g., Donor-CU 221), includes one or more DU(s) (e.g., Donor-DU 222) responsible for time sensitive tasks such as scheduling. The IAB Donor 120 also performs vRAN-L1 functions 223 via the vRAN. One or more UEs may be directly connected to the IAB Donor 120, such as shown with Donor-UE 252.

An IAB Node 130 includes a mobile termination (MT) function, shown as IAB-MT 231, which is responsible for wireless backhaul transmissions and which is connected to the Donor-DU 222. The IAB Node DU function, shown as IAB-DU 232, is responsible for access transmissions to UEs such as an IAB-UE 251 (and, if applicable, to provide access to other backhaul IAB Nodes that might be connected to the IAB Node 130). The IAB Node 130 also includes an IAB-vRAN 233 used for performing vRAN functions at the IAB Node 130. An individual IAB Node can also operate as a parent to other IAB Nodes that are also composed of an MT and a DU.

FIG. 2B depicts a variation to the architecture of FIG. 2A. This variation shows how the IAB Node 130 provides access to the IAB-UE 251 as well as an FRU device identified as IAB-Node-FRU 261. The IAB Donor 120 likewise provides access to the Donor-UE 252 and a Donor-FRU 262. As discussed in the sections below, an FRU device may be used to capture and monitor communication signals occurring at the vRAN node on a per-antenna or per-node basis.

The evaluation of network activity via an FRU device (e.g., at one or both of IAB-Node-FRU 261 and Donor-FRU 262, or other devices) is discussed in the following sections. These and other examples refer to an implementation involving use of a private or standalone 5G Network, supporting a dedicated FRU device, and the use of this dedicated FRU device to transmit a reference signal (e.g., a Sounding Reference Signal (SRS)) for data measurements and comparisons. However, other network architecture variations and adaptations will also be apparent. For instance, although many of the following examples refer to a single dedicated FRU device, other examples may be adapted to use multiple FRU devices (connected to each Donor and/or Node). In such a multi-FRU scenario, a respective FRU device can have a separate (and unique) fingerprint.

Fingerprint Reference Unit (FRU) Framework and Methods

The following introduces approaches for dynamically determining and mitigating communication issues occurring with 5G mobile networking hardware, including in temporary-deployed network settings such as those used with ephemeral or mobile IAB nodes. In an example, these approaches include the unique fingerprinting of IQ data, and the comparison and evaluation of IQ data to determine whether network conditions have degraded as a result of interference, device malfunction or misconfiguration, or other unexpected service disruptions. For instance, FRU devices can be placed according to geographical distance, to monitor communications among different antennas of a single donor or node, or to monitor multiple antennas of a Donor or Nodes that have multiple cells. An IAB Donor or an IAB Node can have multiple radios, with multiple antennas respectively, and FRU device(s) can be placed (or scattered) based on these radios and antennas to monitor different aspects of the network.

In further examples, the comparison and evaluation of IQ data includes the use of an algorithm or process to create, train, and operate an AI learning model to identify service disruption events. This AI learning model and related analysis can be used to identify and mitigate service disruption, whether caused by interference, channel and multi-pass interference, or scheduling constraints.

As will be understood, in the 5G communications setting, IQ reference data (also known as “I/Q data”) generally refers to the components of an observed signal (the in-phase and quadrature phases of a sine wave), providing a representation of how a carrier is modulated in frequency, amplitude, and phase. In some of the following examples, the unique fingerprint of IQ reference data samples produced by the FRU device(s) (referred to herein as iFRU responses) are baselined and then compared against live periodic real-time monitoring of path loss situations produced by the FRU device(s) (referred to herein as pFRU responses).

For instance, if a pFRU response (e.g., a value at time n) is greater than a baseline (e.g., an initial value at time 0) iFRU Response, then a network disruption scenario may be identified. The detection of the network disruption scenario may be used to trigger or control a remedial action, such as to adjust or decommission the ephemeral vRAN (e.g., to disconnect vRAN functions at an IAB node), or to modify operational components of the 5G network in an attempt to resolve the disruption (e.g., to provide some reconfiguration in an attempt to reduce interference). As noted, these scenarios may be further analyzed by AI inference or training models, and such AI inference or training models may be used to recommend or automatically implement network changes that reduce or resolve the disruption.

These data processing operations may be used in a variety of scenarios of a 5G vRAN to detect security breaches or compromised equipment, monitor for mis-configuration or mis-deployment of a network, or detect other improper or incorrect network configurations. Such scenarios may include disruption occurring in private 5G networks, macro 5G networks, and IAB networking scenarios. As a non-limiting example, a security breach or attempts by a man-in-the-middle attack to intercept cellphone data can be easily detected from abnormal FRU data measurements, as compared with earlier fingerprint measurements captured at the FRU device(s). The adaptive nature of these techniques also enable minor remedial actions (e.g., reconfiguring one antenna, changing certain network settings, etc.) or major remedial actions (e.g., turning off one or more antennas, or shutting down the entire IAB node), or recommending and enacting remedial actions that are determined in real-time.

Various processing techniques with AI models and algorithms may be used on an FRU dataset, including processing to classify, sort through, process, and act on FRU response information. Such FRU response information that is relevant to the identification of a network disruption scenario may include but is not limited to measurements in one or more of: Block Error Rate, or BLER (Number of erroneous blocks/the Total number of blocks received); SNR (signal-to-interference/noise ratio), RSRP (Reference Signal Received Power); and RSRQ (Reference Signal Received Quality). Any of these measurements can be used to trigger live (e.g., real-time, or near real-time) adjustments to the Distributed Unit (DU) at a vRAN node. The network adjustments that may be performed include, but are not limited to, the use of one or more of: Modulation and Coding Scheme (MCS) level changes; periodicity of reference signal adjustments; radio unit (RU) compression rate changes; or other changes used to adjust the operation of the radio operations of the vRAN node and the overall 5G network.

Predetermined thresholds can be manually recorded and/or AI-directed based on FRU IQ signatures and recorded data values. The use of adaptive thresholds and AI analysis may be especially useful in temporary vRAN deployments where communication services may be essential, for example 5G applications that are temporarily placed in a particular area for critical communication services (e.g., government, entertainment, commercial use cases). With these critical communication services, initial antenna placement may be changed or disrupted at any time-up to and including the complete loss of an antenna. In this scenario, detection of the disruption at one antenna may allow decommission of the use of the antenna, and a determination that the remaining antennas are determined to be sufficient to continue network operations. However, in this scenario, if the remaining antennas are not sufficient to continue network operations, a complete decommissioning of the radio node (e.g., a self-backhauling IAB-Node) may occur followed by a new deployment of the node.

Similar scenarios that may experience network disruption include the use of nodes deployed for extra capacity, such as at stadium events or in response to natural disasters. In these scenarios, antenna placement may be static, but the path loss may vary based on vegetation, weather, human activity, unforeseen blockages, and/or other sources of interference. Respective detection scenarios may define thresholds that are more accommodating, or may define thresholds which trigger additional self-backhaul provisioning.

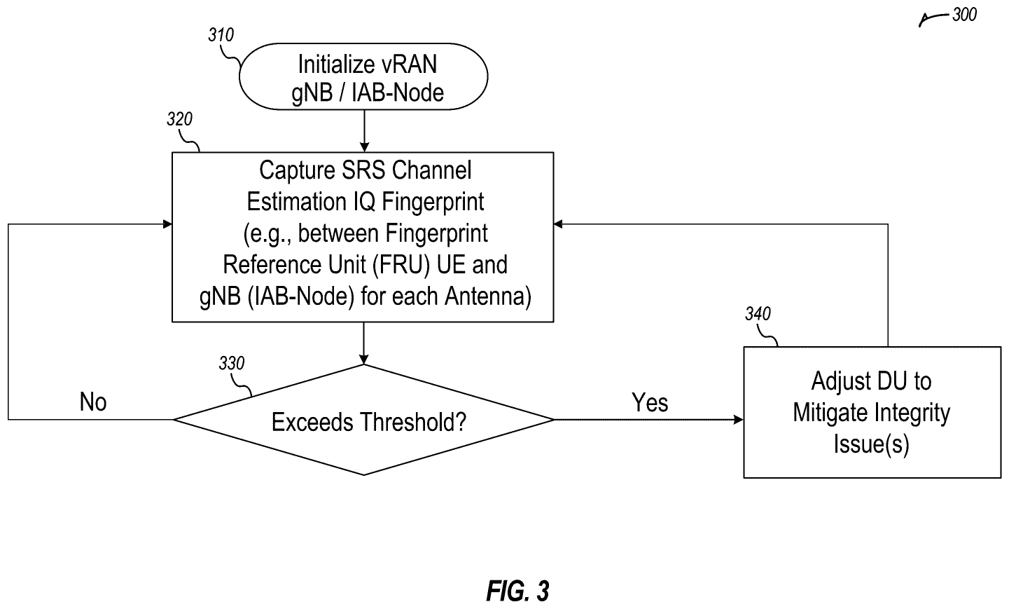

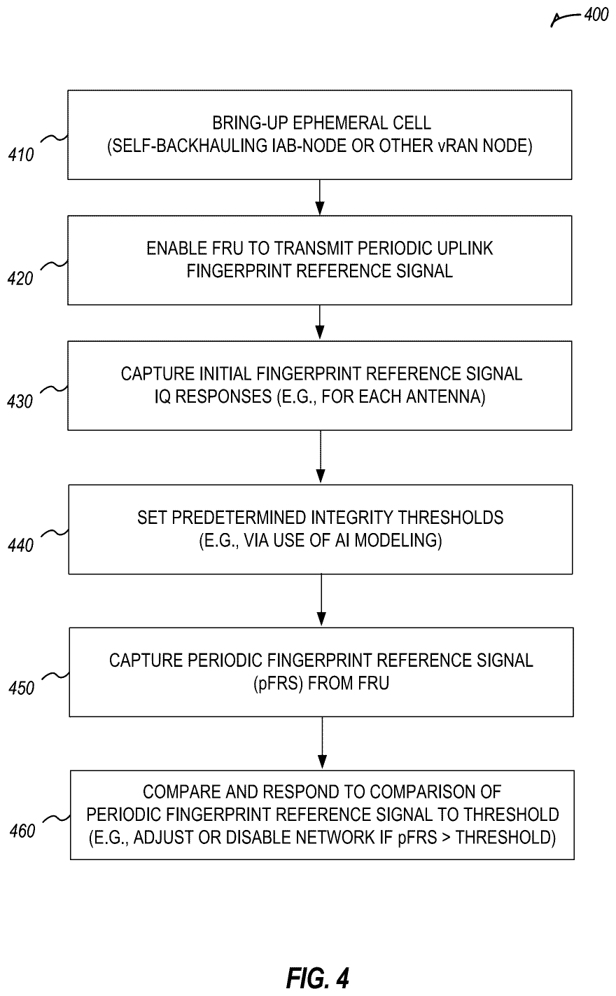

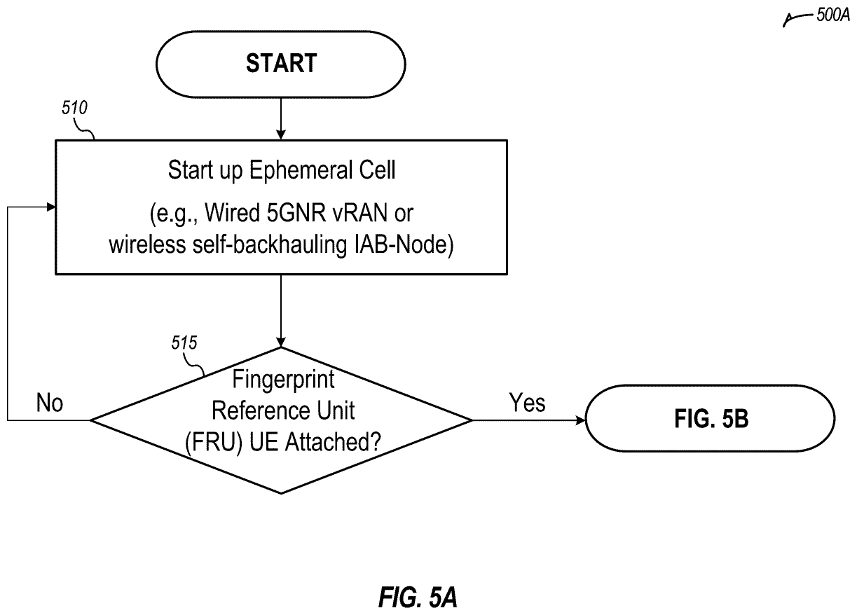

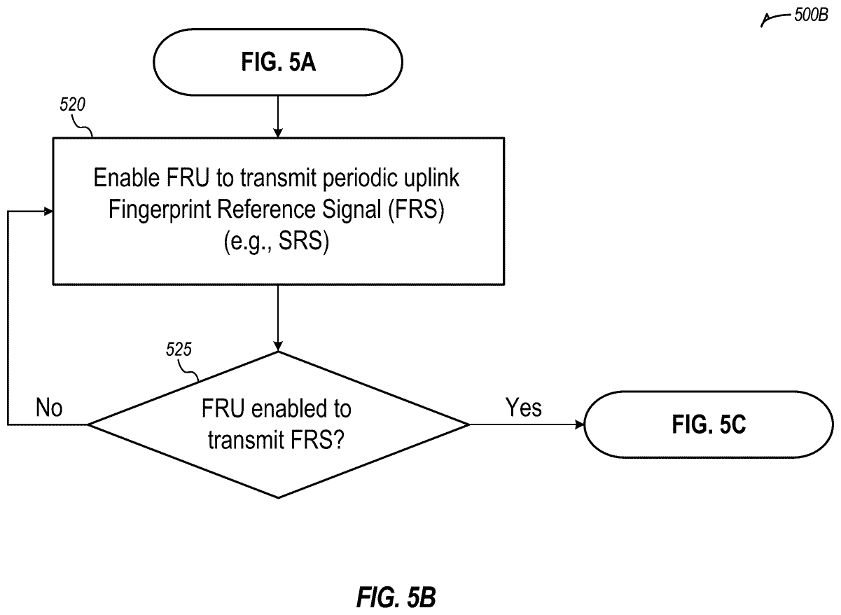

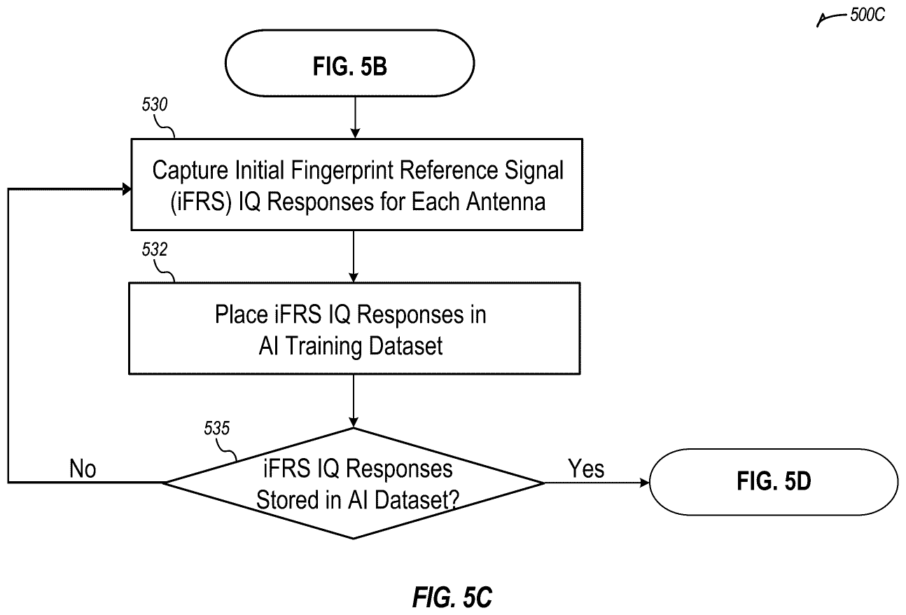

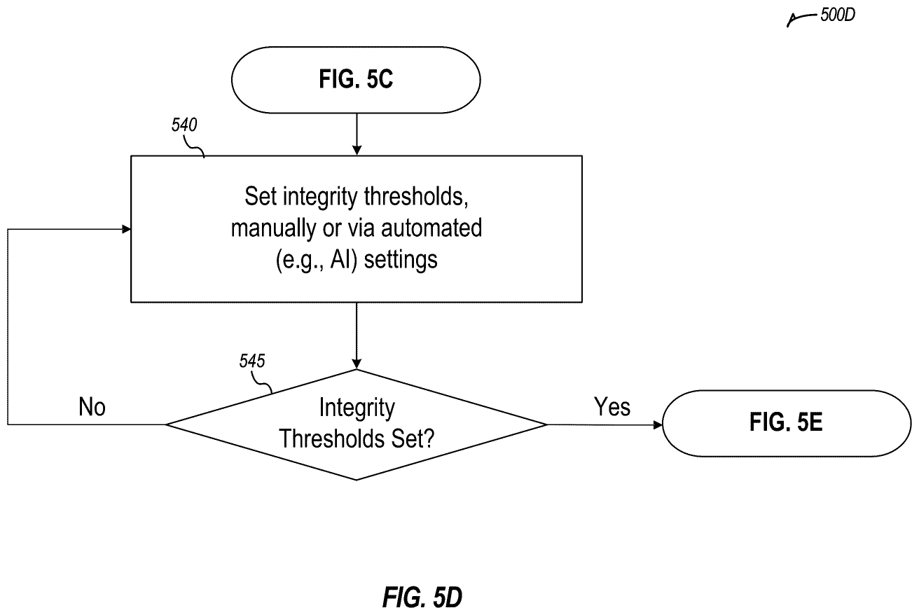

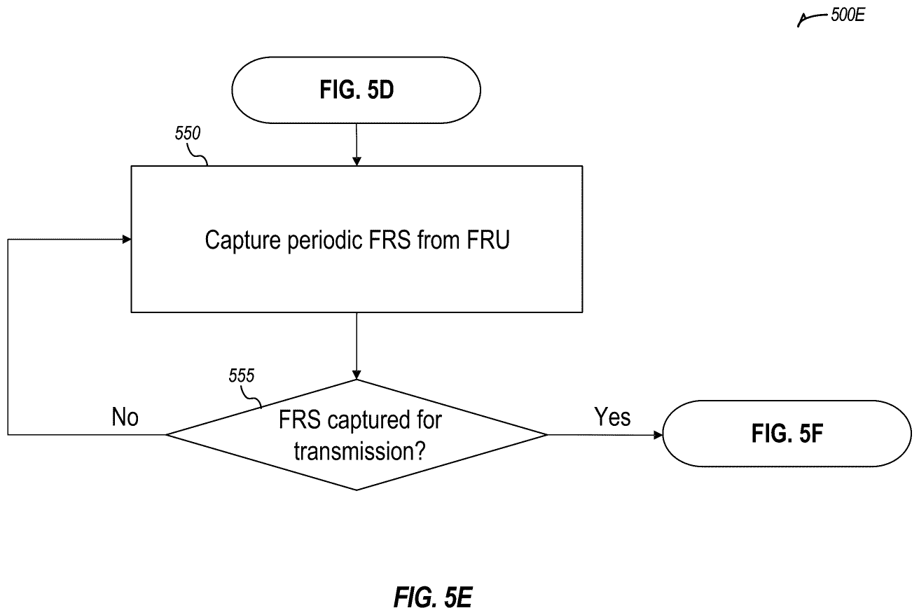

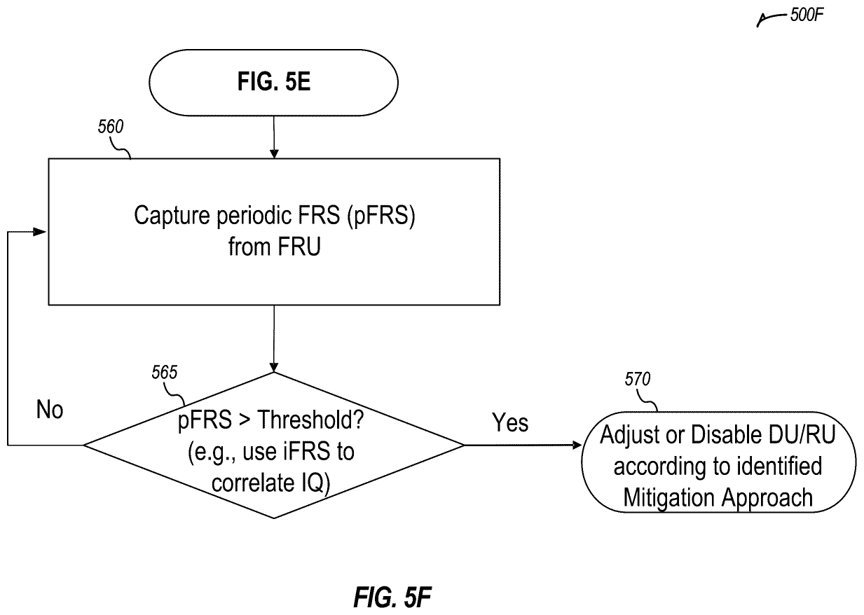

FIG. 3 depicts a flowchart 300 of an approach for an analysis of IQ fingerprint data, according to an example. This approach is directed at the collection of network data and measurements that may be used in combination with an AI Training and Learning functional framework. Although this flowchart and the accompanying diagrams of FIGS. 4 to 5F refer to the use of AI data analysis and evaluation in an IAB node setting, it will be understood that similar approaches would apply to scenarios that do not involve AI data analysis or IAB connectivity.

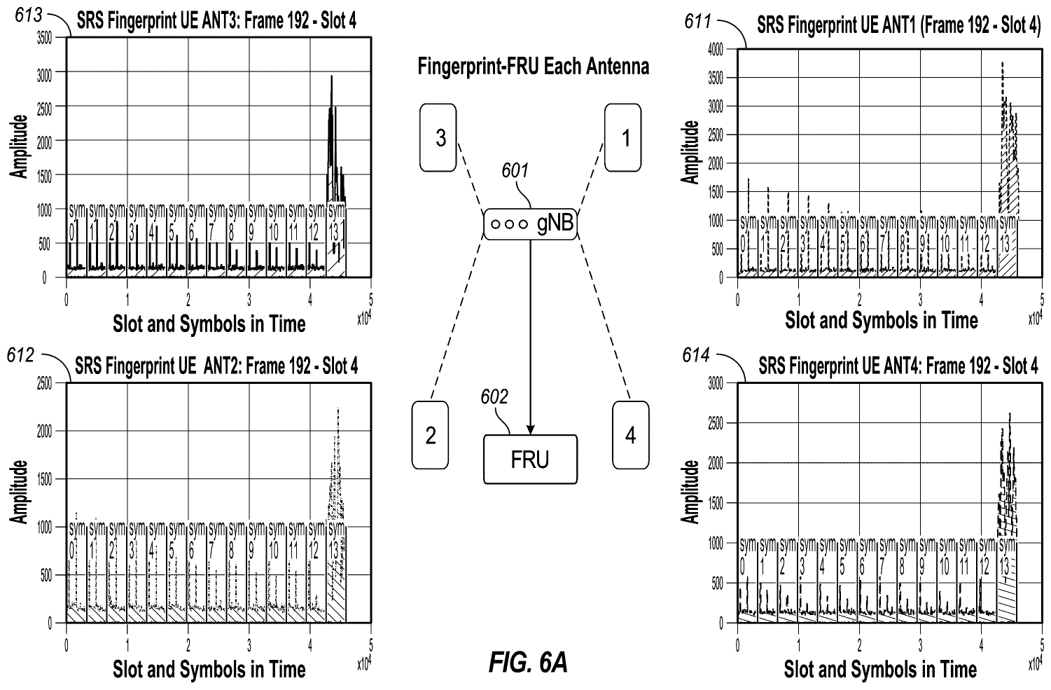

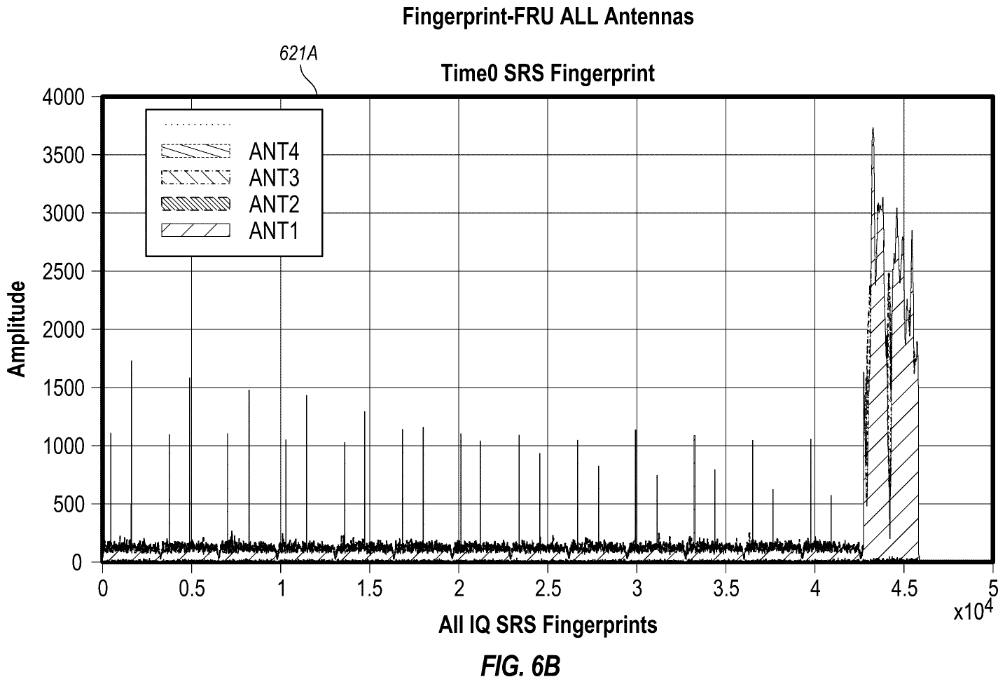

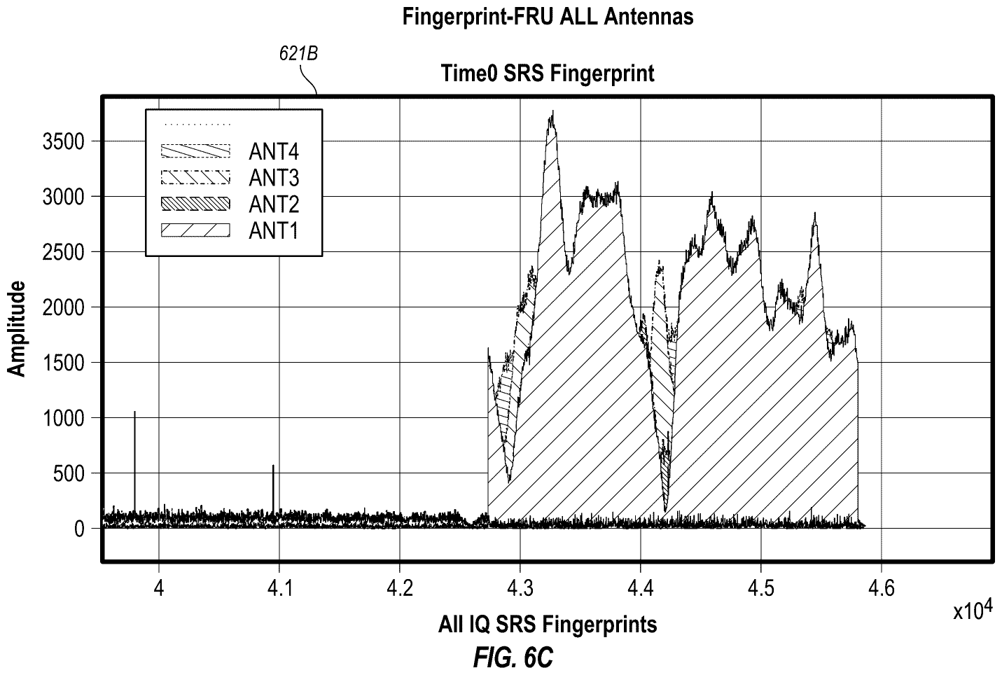

As shown, at operation 310, an initial action includes initializing the vRAN node (e.g., an gNB or IAB-Node) to provide connectivity (e.g., via IAB technologies). Next, at operation 320, data is collected at regular intervals to evaluate for a potential network disruption. In an example, this data includes SRS Channel Estimation IQ data, which is used to produce an IQ Fingerprint. This SRS Channel Estimation IQ data may be collected based on SRS transmissions between the FRU device(s) (e.g., operating as a UE) and a gNB (e.g., the IAB-Node) for multiple respective antennas. The capture of data from individual antennas and from multiple antennas is discussed in more detail below with reference to FIGS. 6B and 6C.

At operation 330, a determination is performed to compare the captured data to a fingerprint threshold and/or other metrics relevant to communication state of the network. In an example, channel characteristics of a periodic fingerprint reference signal are compared against defined or determined thresholds, such as thresholds based on: frequency responses at respective antennas by performing iFFT/iDFT transformations into a time domain to detect channel impulse responses; signal-to-noise ratios; RSRP values; RSRQ values; and other metrics across some or all of the bandwidth of the specific numerology used (e.g., mul numerology=100 MHz). The determination (e.g., when the captured value or a derived measurement exceeds a maximum threshold, or when the captured value or a derived measurement does not meet a minimum threshold) can be used to trigger a network adjustment at operation 340. This network adjustment may include adjusting or modifying the DU, to attempt to mitigate the integrity issue(s) detected within the network.

Examples of thresholds may specifically relate to data provided from measurements of one or more of: Amplitude; Noise Level; Power Levels; and other coarse or fine-grained detectable network parameters. Mitigation examples may include one or more of the following approaches: increasing periodicity; taking one or more antennas offline; adjusting the DU power; adjusting the UE power; adjusting the modulation and coding scheme (MCS) used in the network; or adjusting a time division duplex (TDD) pattern. Threshold values and changes that are evaluated may correspond to percentage changes, absolute or relative value changes, or changes in compliance with dynamic ranges.

In further examples, AI processing operations are performed on an FRU dataset to sort through, process, and act on FRU response information that contains measurements such as BLER, SNR, RSRP, RSRQ, etc. The AI processing results may be used to identify or trigger live (e.g., real-time, or dynamic) adjustments to the DU to mitigate integrity issues. Such adjustments include but are not limited to: MCS level changes, periodicity of reference signal adjustments, RU compression rates, or other changes that can cause an adjustment to network operations.

FIG. 4 depicts a flowchart 400 of an example data processing workflow for the analysis of IQ fingerprint data, with use of initial “fingerprint” reference data values established for the 5G network. Other operations, not shown in the flowchart, may include dynamically adjusting or updating the fingerprint data values.

Operation 410: Bring-up (e.g., initiate and cause operation of) an ephemeral 5G cell (such as self-backhauling IAB-Node or another vRAN Node).

Operation 420: Enable one or more FRU device(s) to transmit a periodic uplink Fingerprint Reference Signal (FRS).

Operation 430: Capture an initial Fingerprint Reference Signal (iFRS), based on IQ responses for respective antennas to the uplink FRS. This iFRS may be periodically reset or re-established.

Operation 440: Set predetermined integrity thresholds, which indicate normal and abnormal operational data values. These integrity thresholds may be set via the use of rules, AI modeling, or other variable outcomes.

Operation 450: Capture a periodic FRS (pFRS) from the one or more FRU devices.

Operation 460: Compare and respond to an evaluation of pFRS to a defined threshold value or data set (e.g., a threshold comparison, which may be dynamically adapted over time). If the evaluation indicates that the pFRS measurement does not meet a minimum threshold, and/or the evaluation indicates that the pFRS measurement exceeds a maximum threshold, then network changes may be made. This may include adjusting or disabling a component of a network based on the comparison of the pFRS to the threshold. In any of the examples discussed herein, the comparison of signal measurements or signal data may involve the use of a Fourier transform (FT), a Fast Fourier Transform (FFT), and other digital signal processing techniques.

FIGS. 5A to 5F depict flowcharts of further approaches for performing an analysis of IQ fingerprint data. The operations performed among FIGS. 5A to 5F may be performed by dedicated hardware, an orchestrating or controlling hardware component, or some coordination of distributed hardware.

FIG. 5A depicts a flowchart 500A with a scenario involving use of an FRU device, such as corresponding to operation 410. This includes, at operation 510, bringing up the ephemeral cell (e.g., a wired 5GNR vRAN or a wireless self-backhauling IAB-Node). The analysis of network data can proceed once the FRU UE is attached to the ephemeral cell at operation 515.

FIG. 5B depicts a flowchart 500B with a scenario involving use of an FRS, such as corresponding to operation 420. This includes, at operation 520, enabling the FRU device attached to the ephemeral cell to transmit a periodic uplink FRS (such as an SRS). The use of the FRU device can proceed at operation 525 after the FRU device is enabled to transmit the FRS.

FIG. 5C depicts a flowchart 500C with a scenario involving use of an iFRS such as corresponding to operation 430. This includes capturing an initial fingerprint reference signal (iFRS), from IQ responses for respective antennas, at operation 530. This may also include placing the iFRS IQ Responses in an AI training data set at operation 532, or similar techniques for recording and analyzing the initial IQ responses from the iFRS from one, multiple, or all antennas. Operations for use of the iFRS proceed at operation 535 after the IQ data is stored in the AI training data set (or, recorded in another data set).

FIG. 5D depicts a flowchart 500D with a scenario involving use of a threshold, such as corresponding to operation 440. This includes, at operation 540, setting one or more integrity thresholds. The integrity thresholds may be determined manually, recommended via an automated data processing method such from outputs of an AI model, or obtained via another source. The use of the integrity thresholds can proceed at operation 545 after the integrity thresholds are set.

FIG. 5E depicts a flowchart 500E with a scenario involving data capture, such as corresponding to operation 450. This includes, at operation 550, periodically capturing (e.g., repeatedly at some time interval) FRS measurements from the connected FRU. The analysis of the FRS can proceed, at operation 555, after the FRS is captured.

FIG. 5F depicts a flowchart 500F with a scenario involving data analysis relative to a determined threshold (e.g., an AI-determined threshold), such as corresponding to operation 460. This includes capturing the pFRS at operation 560, and comparing the pFRS values to the threshold at operation 565 (including, in some examples, using an iFRS to correlate the current IQ data to initial IQ data values). Based on the threshold comparison, adjustments or disabling may be performed on the DU or RU at operation 570 (according to specific mitigation approaches).

FIG. 6A to 6C illustrate measurements from gNB configurations that operate an FRU device for network measurements. Here, these graphs visually show measurements of an SRS fingerprint that is provided with the individual antennas (in FIG. 6A) or collectively with four antennas (in FIG. 6B).

In FIG. 6A, separate data graphs 611, 612, 613, 614 respectively depict SRS fingerprint measurements, provided from an FRU device 602, captured over time from antennas 1, 2, 3, 4 of a gNB 601. The SRS fingerprint measurements at the gNB 601 measure an amplitude of the signal, relative to slots and symbols over time. In FIG. 6B, a single data graph 621A provides an overlay of data that combines the data of the four antennas into a single fingerprint. FIG. 6C provides a more detailed view of the fingerprint based on the combined data from the four antennas in graph 621B.

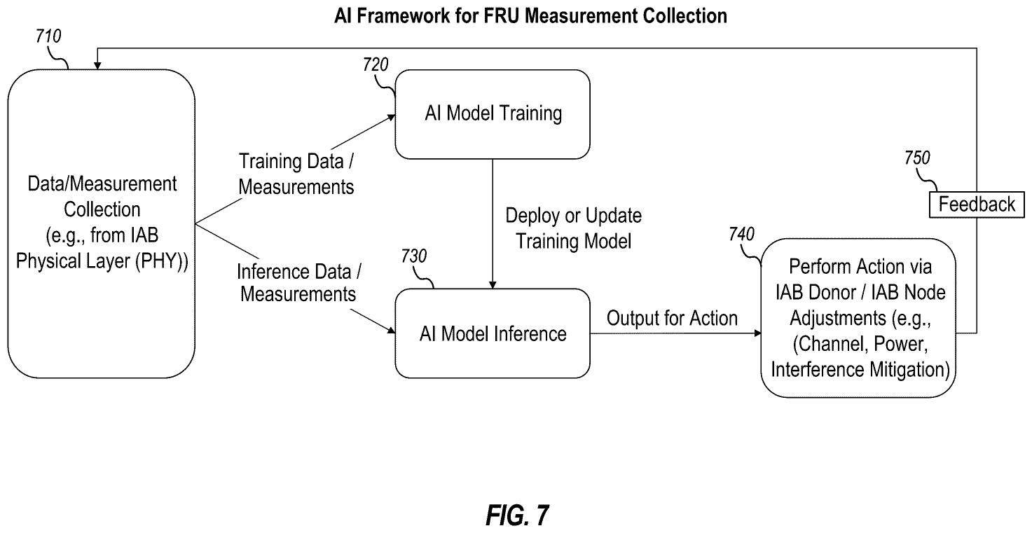

FIG. 7 depicts a flowchart of an example AI training and inference framework for FRU measurement collection. Here, this flowchart shows how IAB physical layer (PHY) data and measurements are collected for use in training and inference scenarios. Other sources of data and measurements may be added to training and inference operations.

Specifically, FIG. 7 depicts aspects of the collection of data and measurements used for training and learning/inferencing operations within a functional framework. First, operation 710 shows a Data/Measurement collection (e.g., from the IAB physical layer (PHY)), with these data/measurements to provide input data for training operations 720 and inference operations 730.

This input data may include but is not limited to IAB gNB PHY and UE data and measurements (such as channel state information, or responses from reference signals such as RSRQ and RSRP) within the currently used channels. This input data may be based on radio communications from not only the frequency channel for the IAB backhaul or access communication, but also from other portions of the available bandwidth associated with numerology of the IAB Donor or Node (for example 100 MHz for n78 numerology 1). Measurements from Physical layers can include 5G NR uplink Fingerprint Reference Signal (FRS) Responses or any other reference signals that could be used to derive measurements and detect the channel state information. Thus, measurements may also include or be based on power and/or amplitude-related responses (e.g., to detect signal strength and anomalies associated with over-the-air transmission).

These and similar measurements can be used as inputs to an AI Model (for training operations 720 or inference operations 730), or to trigger automated alerts and actions that cause adjustments in the network configuration (such as at operation 740). Feedback 750 that is collected from the performed action may also provide additional data measurements for additional training and inference.

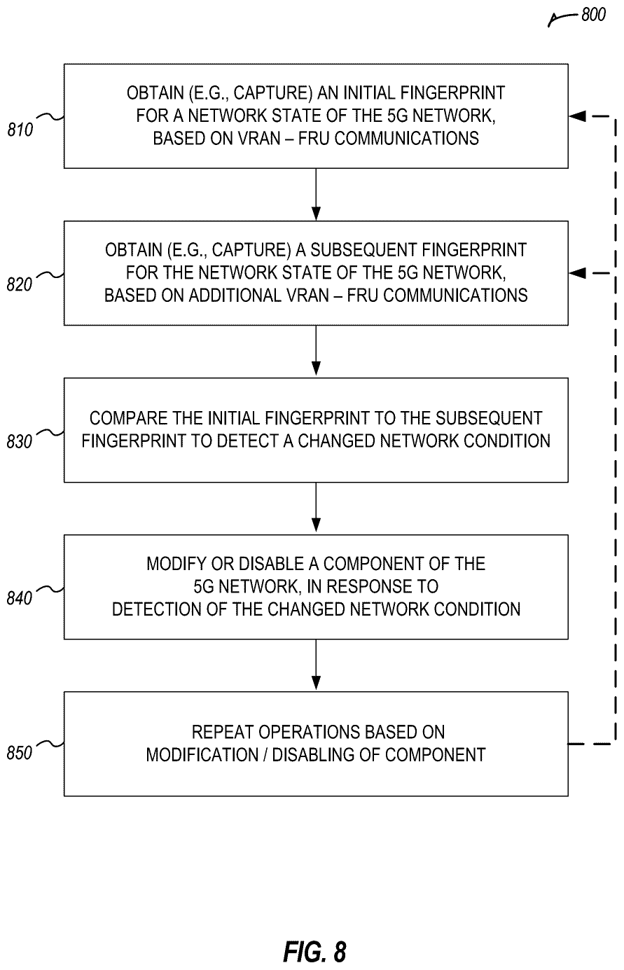

FIG. 8 depicts a flowchart 800 of an example method for implementing and operating a vRAN using the techniques discussed above.

Operation 810 includes obtaining (e.g., capturing) data from initial fingerprint reference, which indicates a network state of the 5G network. As discussed herein, this initial fingerprint reference data may be based on radio communications between a vRAN node and an FRU device connected to the vRAN node, where the FRU device produces the fingerprint reference data from measurements of operational parameters used in the radio communications. In some examples, the obtaining of the initial fingerprint reference data includes capturing the initial fingerprint reference data in response to starting network operations at the vRAN node.

Operation 820 includes obtaining (e.g., capturing) subsequent fingerprint data for the network state of the 5G network, based on additional (e.g., subsequent) vRAN-FRU communications. As discussed herein, the initial fingerprint reference data and the subsequent fingerprint data may be based on IQ data captured from a reference signal, such as based on a reference signal that is transmitted from the FRU device to the vRAN node. Further, the reference signal may be an uplink sounding reference signal (SRS), where the IQ data includes data captured from respective antennas (e.g., each antenna) of the vRAN node.

Operation 830 includes comparing the initial fingerprint reference data to the subsequent fingerprint data of the network state between the vRAN node and the FRU to detect a changed network condition. In a further example, the comparing includes comparing values associated with at least one of: a frequency response associated with channel impulse responses; a signal-to-noise ratio; a RSRP value; or a RSRQ value.

Also in a further example, the comparing of the initial fingerprint reference data to the subsequent fingerprint data includes comparison of a measured value to a threshold. For instance, the threshold may be determined based on use of a trained model, and additionally, the action at the vRAN node may be determined based on use of the trained model (or another trained model). For instance, the threshold may be based on signal measurements of at least one of: amplitude, noise level, or power level.

Operation 840 includes performing an action at the vRAN node, to modify or disable a component of the 5G network. This action may be initiated and performed in response to detection of the changed network condition. In an example, the action at the vRAN node to modify or disable the component of the 5G network includes to perform at least one of: causing an adjustment of power at a distributed unit (DU) of the vRAN node; causing an adjustment of power at a user equipment (UE) wirelessly connected to the vRAN node; changing a Modulation and Coding Scheme (MCS) level; changing a time division duplex (TDD) pattern of the vRAN node; changing a compression rate of a radio unit of the vRAN node; or disabling at least one antenna of the vRAN node.

Operation 850 includes repeating operations based on the modification or disabling of a network component. For example, the modification of a component may be followed by obtaining additional subsequent fingerprints starting at operation 820, to determine if change in the network condition has resolved or improved. If a component is disabled, or if a significant modification has occurred, then operations may be performed starting at 810 to obtain new initial fingerprint reference data.

FIGS. 9A, 9B, and 9C depict additional architectures for supporting vRAN and IAB configurations, according to various examples. First, FIG. 9A provides more details on radio access and interfaces used in a 5G network with IAB. As discussed in 3GPP TS 123 501, IAB approaches enable wireless in-band and out-of-band relaying of NR Uu access traffic via NR Uu backhaul links. The Uu backhaul links can exist between an IAB-node (shown as IAB Node 930) and a gNB in an IAB-Donor (shown as IAB Donor 920), which itself may be another IAB-Node.

The IAB node that supports the Uu interface toward the IAB-Donor or another parent IAB-Node is referred to in the 3GPP TS as an IAB-UE. In some examples, the IAB may reuse the CU/DU architecture defined in TS 38.401. The IAB operations via F1 (e.g., between IAB Donor 920 and IAB Node 930) may not be visible to the 5G Core 910. IAB performs relaying at layer 2, and therefore might not need a local UPF. IAB also supports multi-hop backhauling. Other 3GPP IAB reference architectures (not shown) may include multiple (e.g., two) backhaul hops when connected to a 5G Core 910.

Thus, an IAB architecture for 5G systems has an gNB-DU in the IAB-node that is responsible for providing NR Uu access to UEs (e.g., UE 952) and child IAB-nodes (e.g., via RU2 942). The corresponding gNB-CU function resides on the IAB-Donor gNB 920, which controls IAB-Node 930 gNB-DU via the F1 interface (e.g., provided by RU1 941, which also provides NR Uu access to UEs such as UE 951). An IAB-Node appears as a normal gNB to UEs and other IAB-nodes and allows them to connect to the 5G Core 910. Thus, the IAB-UE function behaves as a UE, and reuses UE procedures to connect to the gNB-DU on a parent IAB-node or IAB-donor for access and backhauling; and to connect the gNB-CU on the IAB-donor via RRC for control of the access and backhaul link.

FIG. 9B depicts a donor-node network arrangement, including the use of multiple FRU devices as discussed herein. Here, a 5GNR Donor RAN 921 uses an O-RU 943 to provide access to a UE1 951 and FRU 961, and a 5GNR Node RAN uses an O-RU 944 to provide access to a UE2 952 and FRU 962. The 5GNR Node RAN 931 connects to the 5GNR Donor RAN 921 via a backhaul (e.g., IAB), and the 5GNR Donor RAN 921 connects to the 5G Core 910 via a wired/fiber connection.

Finally, FIG. 9C depicts a further architecture of a donor-node network arrangement, which may collect data and provide network connectivity using IAB as discussed above. As above, the IAB Donor 920 provides connectivity and control to the IAB Node 930, via F1 and NR FR1a interfaces. In specific examples, the data collected for AJ model training (e.g., for training of an AJ model used for network interference measurement and detection, and/or analysis of fingerprint reference measurements) can include: (1) joint training on data between a parent IAB-Donor and a child IAB-Node; (2) separate training on data from the parent IAB-Donor and a child IAB-Node, with the model used at one location being shared with the other location; or (3) either joint or separate training, using collaboration of data from a donor-UE and or an access-UE and or IAB-MT.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.
Example 1 is a method for analyzing a state of a 5G network, the method comprising: obtaining initial fingerprint reference data of a network state of the 5G network, based on radio communications between a virtualized radio access network (vRAN) node and at least one fingerprint reference unit (FRU) device wirelessly connected to the vRAN node, wherein the FRU device produces the fingerprint reference data from measurements of operational parameters used in the radio communications; comparing the initial fingerprint reference data to subsequent fingerprint data of the network state between the vRAN node and the at least one FRU device to detect a changed network condition; and performing an action at the vRAN node to modify or disable a component of the 5G network, in response to detection of the changed network condition.
In Example 2, the subject matter of Example 1 optionally includes subject matter where the initial fingerprint reference data and the subsequent fingerprint data are based on IQ data captured from a reference signal, and wherein the reference signal is transmitted from the at least one FRU device to the vRAN node.
In Example 3, the subject matter of Example 2 optionally includes subject matter where the reference signal is an uplink sounding reference signal (SRS), and wherein the IQ data includes data captured from respective antennas (e.g., each antenna) of the vRAN node.
In Example 4, the subject matter of any one or more of Examples 1-3 optionally include subject matter where the comparing of the initial fingerprint reference data to the subsequent fingerprint data includes comparing values associated with at least one of: a frequency response associated with channel impulse responses; a signal-to-noise ratio; a RSRP value; or a RSRQ value.
In Example 5, the subject matter of any one or more of Examples 1-4 optionally include subject matter where the comparing of the initial fingerprint to the subsequent fingerprint includes comparison of a measured value to a threshold value.
In Example 6, the subject matter of Example 5 optionally includes subject matter where the threshold value is determined based on use of a trained model, and wherein the action at the vRAN node is determined based on use of the trained model.
In Example 7, the subject matter of any one or more of Examples 5-6 optionally include subject matter where the threshold value is based on signal measurements of at least one of: amplitude, noise level, or power level.
In Example 8, the subject matter of any one or more of Examples 1-7 optionally include subject matter where obtaining the initial fingerprint reference data includes capturing the initial fingerprint reference data in response to starting network operations at the vRAN node.
In Example 9, the subject matter of any one or more of Examples 1-8 optionally include subject matter where the action at the vRAN node to modify or disable the component of the 5G network includes to perform at least one of: cause an adjustment of power at a distributed unit (DU) of the vRAN node; cause an adjustment of power at a user equipment (UE) wirelessly connected to the vRAN node; change a Modulation and Coding Scheme (MCS) level; change a time division duplex (TDD) pattern of the vRAN node; change a compression rate of a radio unit of the vRAN node; or disable at least one antenna of the vRAN node.
In Example 10, the subject matter of any one or more of Examples 1-9 optionally include subject matter where the vRAN node is an Integrated Access Backhaul (JAB) node, wherein the 5G network provides connectivity of the IAB node to an IAB donor node; or optionally, where the vRAN node is an Integrated Access Backhaul (JAB) Donor Node; or optionally, where the vRAN node operates as a non-IAB vRAN gNB.
Example 11 is a device, comprising: processing circuitry; and a memory device including instructions embodied thereon, wherein the instructions, which when executed by the processing circuitry, configure the processing circuitry to perform operations that: obtain initial fingerprint reference data of a network state of a 5G network, based on radio communications between a virtualized radio access network (vRAN) node and at least one fingerprint reference unit (FRU) device (e.g., FRU circuitry) wirelessly connected to the vRAN node, wherein the FRU device produces the fingerprint reference data from measurements of operational parameters used in the radio communications; compare the initial fingerprint reference data to subsequent fingerprint data of the network state between the vRAN node and the at least one FRU device to detect a changed network condition; and perform an action or cause an action to be performed at the vRAN node to modify or disable a component of the 5G network, in response to detection of the changed network condition.
In Example 12, the subject matter of Example 11 optionally includes subject matter where the initial fingerprint reference data and the subsequent fingerprint data are based on IQ data captured from a reference signal, and wherein the reference signal is transmitted from the at least one FRU device to the vRAN node.
In Example 13, the subject matter of Example 12 optionally includes subject matter where the reference signal is an uplink sounding reference signal (SRS), and wherein the IQ data includes data captured from respective antennas (e.g., each antenna) of the vRAN node.
In Example 14, the subject matter of any one or more of Examples 11-13 optionally include subject matter where to compare the initial fingerprint reference data to the subsequent fingerprint data includes to compare values associated with at least one of: a frequency response associated with channel impulse responses; a signal-to-noise ratio; a RSRP value; or a RSRQ value.
In Example 15, the subject matter of any one or more of Examples 11-14 optionally include subject matter where to compare the initial fingerprint reference data to the subsequent fingerprint data includes to compare a measured value to a threshold value.
In Example 16, the subject matter of Example 15 optionally includes subject matter where the threshold value is determined based on use of a trained model, and wherein the action at the vRAN node is determined based on use of the trained model.
In Example 17, the subject matter of any one or more of Examples 15-16 optionally include subject matter where the threshold value is based on signal measurements of at least one of: amplitude, noise level, or power level.
In Example 18, the subject matter of any one or more of Examples 11-17 optionally include subject matter where to obtain the initial fingerprint reference data includes to capture the initial fingerprint reference data in response to starting network operations at the vRAN node.
In Example 19, the subject matter of any one or more of Examples 11-18 optionally include subject matter where the action at the vRAN node to modify or disable the component of the 5G network includes to perform at least one of: cause an adjustment of power at a distributed unit (DU) of the vRAN node; cause an adjustment of power at a user equipment (UE) wirelessly connected to the vRAN node; change a Modulation and Coding Scheme (MCS) level; change a time division duplex (TDD) pattern of the vRAN node; change a compression rate of a radio unit of the vRAN node; or disable at least one antenna of the vRAN node.
In Example 20, the subject matter of any one or more of Examples 11-19 optionally include subject matter where the vRAN node is an Integrated Access Backhaul (JAB) node, wherein the 5G network provides connectivity of the IAB node to an IAB donor node; or optionally, where the vRAN node is an Integrated Access Backhaul (JAB) Donor Node; or optionally, where the vRAN node operates as a non-IAB vRAN gNB.
Example 21 is at least one non-transitory machine-readable storage medium comprising instructions stored thereupon, which when executed by processing circuitry of a computing machine, cause the processing circuitry to: obtain initial fingerprint reference data of a network state of a 5G network, based on radio communications between a virtualized radio access network (vRAN) node and at least one fingerprint reference unit (FRU) device (e.g., FRU circuitry) wirelessly connected to the vRAN node, wherein the FRU device produces the fingerprint reference data from measurements of operational parameters used in the radio communications; compare the initial fingerprint reference data to subsequent fingerprint data of the network state between the vRAN node and the at least one FRU device to detect a changed network condition; and perform an action or cause an action to be performed at the vRAN node to modify or disable a component of the 5G network, in response to detection of the changed network condition.
In Example 22, the subject matter of Example 21 optionally includes subject matter where the initial fingerprint reference data and the subsequent fingerprint data are based on IQ data captured from a reference signal, and wherein the reference signal is transmitted from the at least one FRU device to the vRAN node.
In Example 23, the subject matter of Example 22 optionally includes subject matter where the reference signal is an uplink sounding reference signal (SRS), and wherein the IQ data includes data captured from respective antennas (e.g., each antenna) of the vRAN node.
In Example 24, the subject matter of any one or more of Examples 21-23 optionally include subject matter where to compare the initial fingerprint reference data to the subsequent fingerprint data includes to compare values associated with at least one of: a frequency response associated with channel impulse responses; a signal-to-noise ratio; a RSRP value; or a RSRQ value.
In Example 25, the subject matter of any one or more of Examples 21-24 optionally include subject matter where to compare the initial fingerprint reference data to the subsequent fingerprint data includes to compare a measured value to a threshold value.
In Example 26, the subject matter of Example 25 optionally includes subject matter where the threshold value is determined based on use of a trained model, and wherein the action at the vRAN node is determined based on use of the trained model.
In Example 27, the subject matter of any one or more of Examples 25-26 optionally include subject matter where the threshold value is based on signal measurements of at least one of: amplitude, noise level, or power level.
In Example 28, the subject matter of any one or more of Examples 21-27 optionally include subject matter where to obtain the initial fingerprint reference data includes to capture the initial fingerprint reference data in response to starting network operations at the vRAN node.
In Example 29, the subject matter of any one or more of Examples 21-28 optionally include subject matter where the action at the vRAN node to modify or disable the component of the 5G network includes to perform at least one of: cause an adjustment of power at a distributed unit (DU) of the vRAN node; cause an adjustment of power at a user equipment (UE) wirelessly connected to the vRAN node; change a Modulation and Coding Scheme (MCS) level; change a time division duplex (TDD) pattern of the vRAN node; change a compression rate of a radio unit of the vRAN node; or disable at least one antenna of the vRAN node.
In Example 30, the subject matter of any one or more of Examples 21-29 optionally include subject matter where the vRAN node is an Integrated Access Backhaul (JAB) node, wherein the 5G network provides connectivity of the IAB node to an IAB donor node; or optionally, where the vRAN node is an Integrated Access Backhaul (JAB) Donor Node; or optionally, where the vRAN node operates as a non-IAB vRAN gNB.
Example 31 is a device, comprising: processing circuitry; and a memory device including instructions embodied thereon, wherein the instructions, which when executed by the processing circuitry, configure the processing circuitry to perform operations for distributed unit IQ data sample fingerprinting, optionally with use of self-correcting IAB Node capabilities, in a terrestrial-based or non-terrestrial-supported (e.g., NTN) 5G network in accordance with the techniques discussed herein.
Example 32 is a method, comprising a plurality of operations executed with a processor and memory of a device, to perform operations for distributed unit IQ data sample fingerprinting, optionally with use of self-correcting IAB Node capabilities, in a terrestrial-based or non-terrestrial-supported (e.g., NTN) 5G network in accordance with the techniques discussed herein.
Example 33 is a device-readable storage medium including instructions, wherein the instructions, when executed by a processing circuitry of a device, cause the processing circuitry to perform operations for distributed unit IQ data sample fingerprinting, optionally with use of self-correcting IAB Node capabilities, in a terrestrial-based or non-terrestrial-supported (e.g., NTN) 5G network in accordance with the techniques discussed herein.
Example 34 is an apparatus, comprising respective means for distributed unit IQ data sample fingerprinting optionally with use of self-correcting IAB Node capabilities, in a terrestrial-based or non-terrestrial-supported (e.g., NTN) 5G network in accordance with the techniques discussed herein.
Example 35 is a 5G communication network, comprising network equipment configured for distributed unit IQ data sample fingerprinting, optionally with use of self-correcting IAB Node capabilities, in a terrestrial-based or non-terrestrial-supported (e.g., NTN) 5G network in accordance with the techniques discussed herein.
Example 36 is a virtualized Radio Access Network (vRAN) device, comprising computing hardware executing instructions for distributed unit IQ data sample fingerprinting, optionally with use of self-correcting IAB Node capabilities, for control of a terrestrial-based or non-terrestrial-supported (e.g., NTN) 5G network in accordance with the techniques discussed herein.
Example 37 is a network comprising respective devices and device communication mediums for performing any of the operations or techniques discussed herein.
Example 38 is specially programmed circuitry configured to perform any of the operations or techniques discussed herein.
Example 39 is a system comprising respective components arranged or configured to perform any of the operations or techniques discussed herein.
Example 40 is a method, performed using circuitry of a computing device, arranged or configured to perform any of the operations or techniques discussed herein.

Implementation in Edge Computing Scenarios

It will be understood that the present communication and networking arrangements may be implemented with many aspects of edge computing strategies and deployments. Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

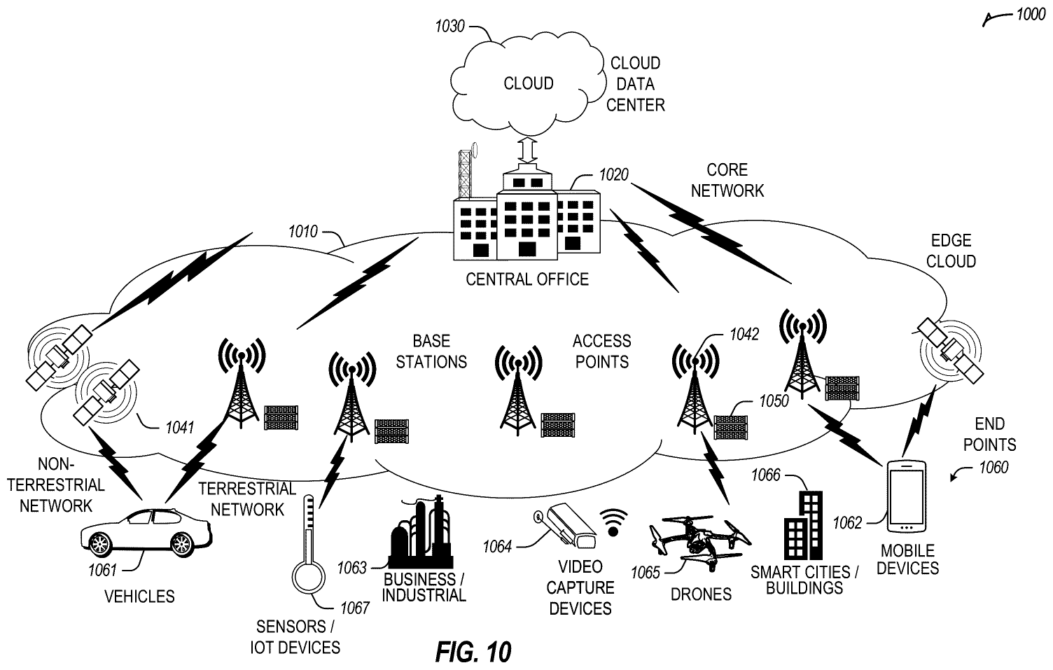

FIG. 10 is a block diagram 1000 showing an overview of a configuration for edge computing, which includes a layer of processing referenced in many of the current examples as an “edge cloud”. This network topology, which may include a number of conventional networking layers (including those not shown herein), may be extended through use of the satellite and non-terrestrial network communication arrangements discussed herein.

As shown, the edge cloud 1010 is co-located at an edge location, such as a satellite vehicle 1041, a base station 1042, a local processing hub 1050, or a central office 1020, and thus may include multiple entities, devices, and equipment instances. The edge cloud 1010 is located much closer to the endpoint (consumer and producer) data sources 1060 (e.g., autonomous vehicles 1061, user equipment 1062, business and industrial equipment 1063, video capture devices 1064, drones 1065, smart cities and building devices 1066, sensors and IoT devices 1067, etc.) than the cloud data center 1030. Compute, memory, and storage resources which are offered at the edges in the edge cloud 1010 are critical to providing ultra-low or improved latency response times for services and functions used by the endpoint data sources 1060 as well as reduce network backhaul traffic from the edge cloud 1010 toward cloud data center 1030 thus improving energy consumption and overall network usages among other benefits.

Compute, memory, and storage are scarce resources, and generally decrease depending on the edge location (e.g., fewer processing resources being available at consumer end point devices than at a base station or at a central office). However, the closer that the edge location is to the endpoint (e.g., UEs), the more that space and power is constrained. Thus, edge computing, as a general design principle, attempts to minimize the amount of resources needed for network services, through the distribution of more resources which are located closer both geographically and in network access time.

In an example, an edge cloud architecture extends beyond typical deployment limitations to address restrictions that some network operators or service providers may have in their own infrastructures. These include, variation of configurations based on the edge location (because edges at a base station level, for instance, may have more constrained performance); configurations based on the type of compute, memory, storage, fabric, acceleration, or like resources available to edge locations, tiers of locations, or groups of locations; the service, security, and management and orchestration capabilities; and related objectives to achieve usability and performance of end services.

Edge computing is a developing paradigm where computing is performed at or closer to the “edge” of a network, typically through the use of a compute platform implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Likewise, within edge computing deployments, there may be scenarios in services which the compute resource may be “moved” to the data, as well as scenarios in which the data may be “moved” to the compute resource. Or as an example, base station (or satellite vehicle) compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 10, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but may not be optimal for highly time varying data, such as a collision, traffic light change, etc. and may fail in attempting to meet latency challenges. Depending on the real-time needs of a communications context, a hierarchical structure of data processing and storage nodes may be defined in an edge computing deployment. For example, such a deployment may include local ultra-low-latency processing, regional storage and processing as well as remote cloud data center based storage and processing. Key performance indicators (KPIs) may be used to identify where sensor data is appropriately transferred and where it is processed or stored. This typically depends on the ISO layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud data center.

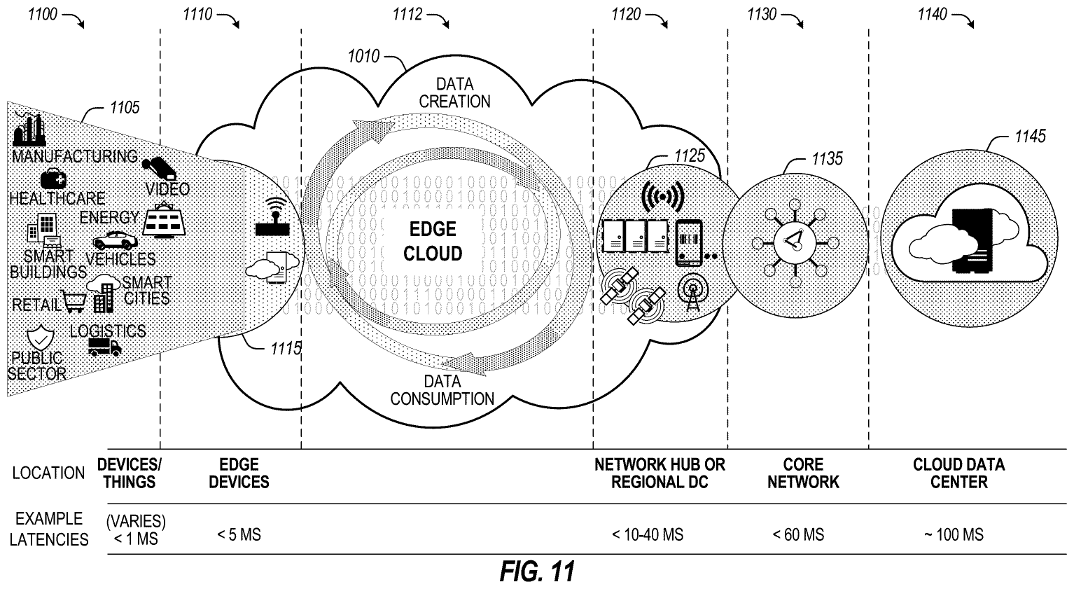

FIG. 11 illustrates operational layers among endpoints, an edge cloud, and cloud computing environments. Specifically, FIG. 11 depicts examples of computational use cases 1105, utilizing the edge cloud 1010 among multiple illustrative layers of network computing. The layers begin at an endpoint (devices and things) layer 1100, which accesses the edge cloud 1010 to conduct data creation, analysis, and data consumption activities. The edge cloud 1010 may span multiple network layers, such as an edge devices layer 1110 having gateways, on-premise servers, or network equipment (nodes 1115) located in physically proximate edge systems; a network access layer 1120, encompassing base stations, radio processing units, network hubs, regional data centers (DC), or local network equipment (equipment 1125); and any equipment, devices, or nodes located therebetween (in layer 1112, not illustrated in detail). The network communications within the edge cloud 1010 and among the various layers may occur via any number of wired or wireless mediums, including via connectivity architectures and technologies not depicted.

Examples of latency with terrestrial networks, resulting from network communication distance and processing time constraints, may range from less than a millisecond (ms) when among the endpoint layer 1100, under 5 ms at the edge devices layer 1110, to even between 10 to 40 ms when communicating with nodes at the network access layer 1120. (Variation to these latencies is expected with use of non-terrestrial networks). Beyond the edge cloud 1010 are core network and cloud data center layers 1130 and 1140, with increasing latency (e.g., between 50-60 ms at the core network layer 1130, to 100 or more ms at the cloud data center layer). As a result, operations at a core network data center 1135 or a cloud data center 1145, with latencies of at least 50 to 100 ms or more, will not be able to accomplish many time-critical functions of the use cases 1105. These latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1135 or a cloud data center 1145, a central office or content data network may be considered as being located within a “near edge” layer (“near” to the cloud, having high latency values when communicating with the devices and endpoints of the use cases 1105), whereas an access point, base station, on-premise server, or network gateway may be considered as located within a “far edge” layer (“far” from the cloud, having low latency values when communicating with the devices and endpoints of the use cases 1105). It will be understood that other categorizations of a particular network layer as constituting a “close”, “local”, “near”, “middle”, or “far” edge may be based on latency, distance, number of network hops, or other measurable characteristics, as measured from a source in any of the network layers 1100-1140.

The various use cases 1105 may access resources under usage pressure from incoming streams, due to multiple services utilizing the edge cloud. To achieve results with low latency, the services executed within the edge cloud 1010 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at respective layers in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement operations to remediate.

Thus, with these variations and service features in mind, edge computing within the edge cloud 1010 may provide the ability to serve and respond to multiple applications of the use cases 1105 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), etc.), which might not leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power uses greater memory bandwidth. Likewise, improved security of hardware and root of trust trusted functions are also implicated, because edge locations may be unmanned and may even need permissioned access (e.g., when housed in a third-party location). Such issues are magnified in the edge cloud 1010 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1010 (network layers 1100-1140), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), communication services provider (CoSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, circuitry, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1010.

As such, the edge cloud 1010 is formed from network components and functional features operated by and within edge gateway nodes, edge aggregation nodes, or other edge compute nodes among network layers 1110-1130. The edge cloud 1010 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 1010 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

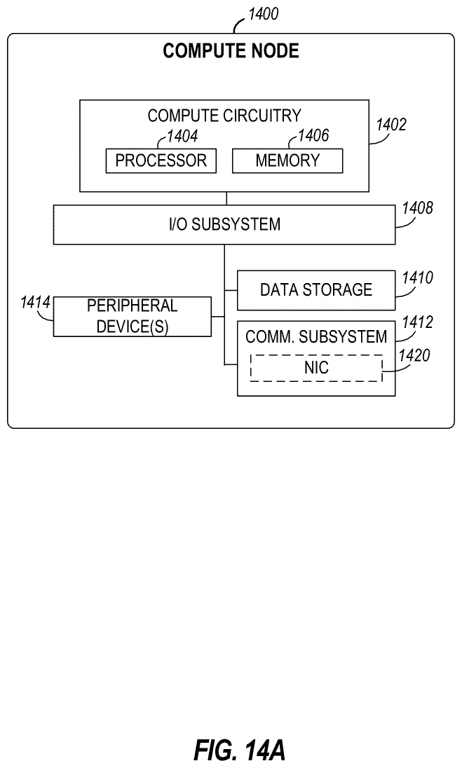

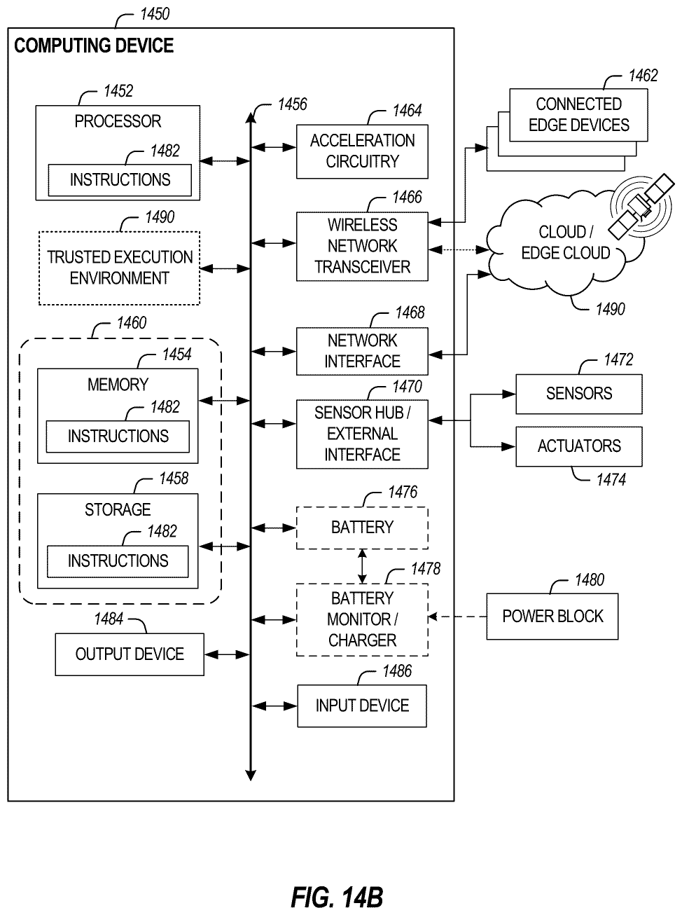

The network components of the edge cloud 1010 may be servers, multi-tenant servers, appliance computing devices, and/or any other type of computing devices. For example, a node of the edge cloud 1010 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 14B. The edge cloud 1010 may also include one or more servers and/or one or more multi-tenant servers. Such a server may include an operating system and implement a virtual computing environment. A virtual computing environment may include a hypervisor managing (e.g., spawning, deploying, shutting down, etc.) one or more virtual machines, one or more containers, etc. Such virtual computing environments provide an execution environment in which one or more applications and/or other software, code or scripts may execute while being isolated from one or more other applications, software, code or scripts.

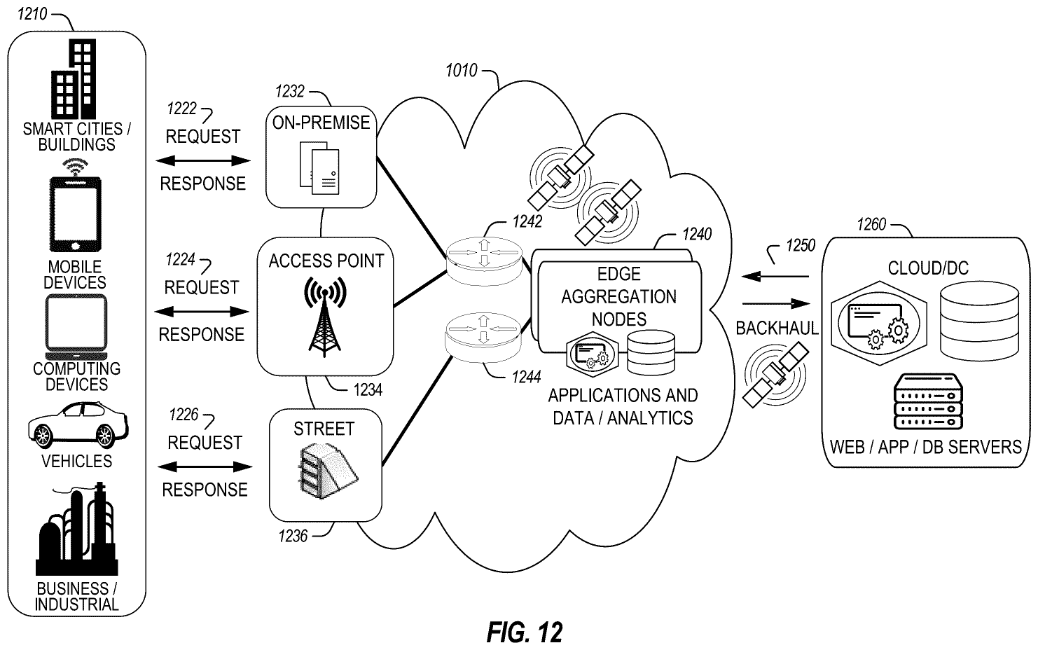

In FIG. 12, various client endpoints 1210 (in the form of mobile devices, computers, autonomous vehicles, business computing equipment, industrial processing equipment) exchange requests and responses that are specific to the type of endpoint network aggregation. For instance, client endpoints 1210 may obtain network access via a wired broadband network, by exchanging requests and responses 1222 through an on-premise network system 1232. Some client endpoints 1210, such as mobile computing devices, may obtain network access via a wireless broadband network, by exchanging requests and responses 1224 through an access point (e.g., cellular network tower) 1234. Some client endpoints 1210, such as autonomous vehicles may obtain network access for requests and responses 1226 via a wireless vehicular network through a street-located network system 1236. However, regardless of the type of network access, the TSP may deploy aggregation points 1242, 1244 within the edge cloud 1010 to aggregate traffic and requests. Thus, within the edge cloud 1010, the TSP may deploy various compute and storage resources, such as at edge aggregation nodes 1240 (including those located at satellite vehicles), to provide requested content. The edge aggregation nodes 1240 and other systems of the edge cloud 1010 are connected to a cloud or data center 1260, which uses a backhaul network 1250 (such as a satellite backhaul) to fulfill higher-latency requests from a cloud/data center for websites, applications, database servers, etc. Additional or consolidated instances of the edge aggregation nodes 1240 and the aggregation points 1242, 1244, including those deployed on a single server framework, may also be present within the edge cloud 1010 or other areas of the TSP infrastructure.

At a more generic level, an edge computing system may be described to encompass any number of deployments operating in the edge cloud 1010, which provide coordination from client and distributed computing devices. FIG. 11 provides a further abstracted overview of layers of distributed compute deployed among an edge computing environment for purposes of illustration.

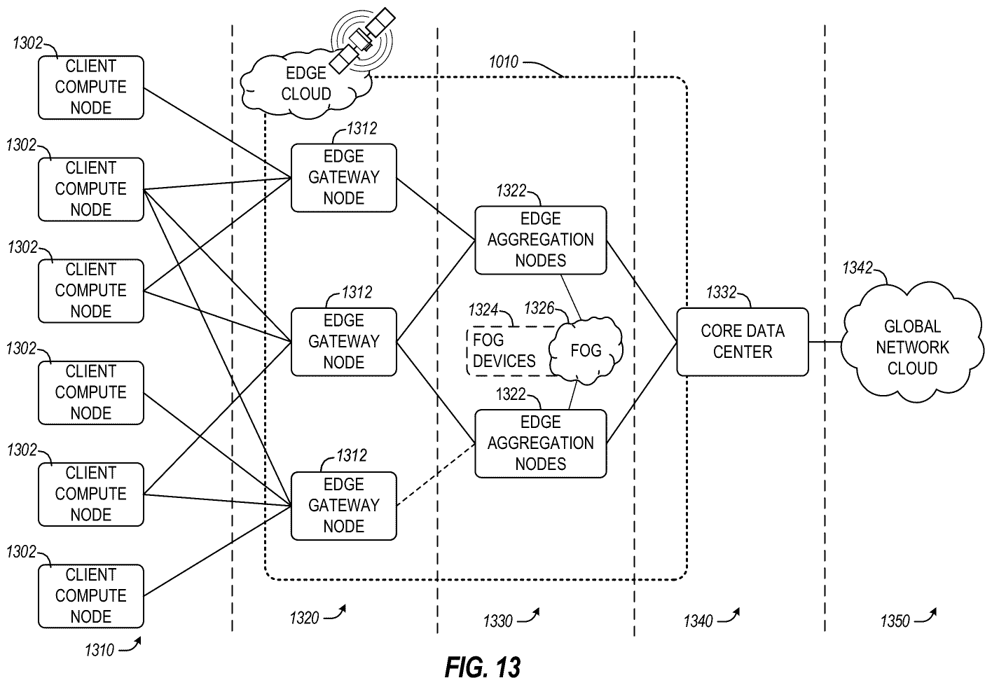

FIG. 13 generically depicts an edge computing system for providing edge services and applications to multi-stakeholder entities, as distributed among one or more client compute nodes 1302, one or more edge gateway nodes 1312, one or more edge aggregation nodes 1322, one or more core data centers 1332, and a global network cloud 1342, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

A respective node or device of the edge computing system is located at a particular layer corresponding to layers 1100, 1110, 1120, 1130, 1140. For example, the client compute nodes 1302 are located at an endpoint layer 1100, while the edge gateway nodes 1312 are located at an edge devices layer 1110 (local level) of the edge computing system. Additionally, the edge aggregation nodes 1322 (and/or fog devices 1324, if arranged or operated with or among a fog networking configuration 1326) are located at a network access layer 1120 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 1332 is located at a core network layer 1130 (e.g., a regional or geographically-central level), while the global network cloud 1342 is located at a cloud data center layer 1140 (e.g., a national or global layer). The use of “core” is provided as a term for a centralized network location-deeper in the network-which is accessible by multiple edge nodes or components; however, a “core” does not necessarily designate the “center” or the deepest location of the network. Accordingly, the core data center 1332 may be located within, at, or near the edge cloud 1010.

Although an illustrative number of client compute nodes 1302, edge gateway nodes 1312, edge aggregation nodes 1322, core data centers 1332, global network clouds 1342 are shown in FIG. 13, it should be appreciated that the edge computing system may include more or fewer devices or systems at respective layers. Additionally, as shown in FIG. 13, the number of components of the layers 1100, 1110, 1120, 1130, 1140 generally increases at respective lower levels (e.g., when moving closer to endpoints). As such, one edge gateway node 1312 may service multiple client compute nodes 1302, and one edge aggregation node 1322 may service multiple edge gateway nodes 1312.

Consistent with the examples provided herein, a client compute node 1302 may be embodied as any type of end point component, device, appliance, or “thing” capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1010.

As such, the edge cloud 1010 is formed from network components and functional features operated by and within the edge gateway nodes 1312 and the edge aggregation nodes 1322 of layers 1120, 1130, respectively. The edge cloud 1010 may be embodied as any type of network that provides edge computing and/or storage resources which are proximately located to radio access network (RAN) capable endpoint devices (e.g., mobile computing devices, IoT devices, smart devices, etc.), which are shown in FIG. 11 as the client compute nodes 1302. In other words, the edge cloud 1010 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 1010 may form a portion of or otherwise provide an ingress point into or across a fog networking configuration 1326 (e.g., a network of fog devices 1324, not shown in detail), which may be embodied as a system-level horizontal and distributed architecture that distributes resources and services to perform a specific function. For instance, a coordinated and distributed network of fog devices 1324 may perform computing, storage, control, or networking aspects in the context of an IoT system arrangement. Other networked, aggregated, and distributed functions may exist in the edge cloud 1010 between the cloud data center layer 1140 and the client endpoints (e.g., client compute nodes 1302). Some of these are discussed in the following sections in the context of network functions or service virtualization, including the use of virtual edges and virtual services which are orchestrated for multiple stakeholders.

The edge gateway nodes 1312 and the edge aggregation nodes 1322 cooperate to provide various edge services and security to the client compute nodes 1302. Furthermore, because a client compute node 1302 may be stationary or mobile, an edge gateway node 1312 may cooperate with other edge gateway devices to propagate presently provided edge services and security as the corresponding client compute node 1302 moves about a region. To do so, the edge gateway nodes 1312 and/or edge aggregation nodes 1322 may support multiple tenancy and multiple stakeholder configurations, in which services from (or hosted for) multiple service providers and multiple consumers may be supported and coordinated across a single or multiple compute devices.

In further examples, any of the compute nodes or devices discussed with reference to the present computing systems and environment may be fulfilled based on the components depicted in FIGS. 14A and 14B. A compute node may be embodied as a type of device, appliance, computer, or other “thing” capable of communicating with other edge, networking, or endpoint components.

In the simplified example depicted in FIG. 14A, an edge compute node 1400 includes a compute engine (also referred to herein as “compute circuitry”) 1402, an input/output (I/O) subsystem 1408, data storage device 1410, a communication circuitry 1412 subsystem, and, optionally, one or more peripheral devices 1414. In other examples, a compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1400 may be embodied as any type of engine, device, or collection of devices capable of performing various compute functions. In some examples, the compute node 1400 may be embodied as a single device such as an integrated circuit, an embedded system, a field-programmable gate array (FPGA), a system-on-a-chip (SOC), or other integrated system or device. In the illustrative example, the compute node 1400 includes or is embodied as a processor 1404 and a memory 1406. The processor 1404 may be embodied as any type of processor capable of performing the functions described herein (e.g., executing an application). For example, the processor 1404 may be embodied as a multi-core processor(s), a microcontroller, or other processor or processing/controlling circuit. In some examples, the processor 1404 may be embodied as, include, or be coupled to an FPGA, an application specific integrated circuit (ASIC), reconfigurable hardware or hardware circuitry, or other specialized hardware to facilitate performance of the functions described herein.

The main memory 1406 may be embodied as any type of volatile (e.g., dynamic random access memory (DRAM), etc.) or non-volatile memory or data storage capable of performing the functions described herein. Volatile memory may be a storage medium that uses power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D Xpoint™ memory, other storage class memory), or other byte addressable write-in-place nonvolatile memory devices. The memory device may refer to the die itself and/or to a packaged memory product. In some examples, 3D crosspoint memory (e.g., Intel 3D Xpoint™ memory) may comprise a transistor-less stackable cross point architecture in which memory cells sit at the intersection of word lines and bit lines and are individually addressable and in which bit storage is based on a change in bulk resistance. In some examples, all or a portion of the main memory 1406 may be integrated into the processor 1404. The main memory 1406 may store various software and data used during operation such as one or more applications, data operated on by the application(s), libraries, and drivers.

The compute circuitry 1402 is communicatively coupled to other components of the compute node 1400 via the I/O subsystem 1408, which may be embodied as circuitry and/or components to facilitate input/output operations with the compute circuitry 1402 (e.g., with the processor 1404 and/or the main memory 1406) and other components of the compute circuitry 1402. For example, the I/O subsystem 1408 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1408 may form a portion of a system-on-a-chip (SoC) and be incorporated, along with one or more of the processor 1404, the main memory 1406, and other components of the compute circuitry 1402, into the compute circuitry 1402.

The one or more illustrative data storage device 1410 may be embodied as any type of devices configured for short-term or long-term storage of data such as, for example, memory devices and circuits, memory cards, hard disk drives, solid-state drives, or other data storage devices. A data storage device 1410 may include a system partition that stores data and firmware code for the data storage device 1410. A data storage device 1410 may also include one or more operating system partitions that store data files and executables for operating systems depending on, for example, the type of compute node 1400.

The communication circuitry 1412 may be embodied as any communication circuit, device, or collection thereof, capable of enabling communications over a network between the compute circuitry 1402 and another compute device (e.g., an edge gateway node 1312 of an edge computing system). The communication circuitry 1412 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, etc.) to effect such communication.

The illustrative communication circuitry 1412 includes a network interface controller (NIC) 1420, which may also be referred to as a host fabric interface (HFI). The NIC 1420 may be embodied as one or more add-in-boards, daughter cards, network interface cards, controller chips, chipsets, or other devices that may be used by the compute node 1400 to connect with another compute device (e.g., an edge gateway node 1312). In some examples, the NIC 1420 may be embodied as part of a system-on-a-chip (SoC) that includes one or more processors, or included on a multichip package that also contains one or more processors. In some examples, the NIC 1420 may include a local processor (not shown) and/or a local memory (not shown) that are both local to the NIC 1420. In such examples, the local processor of the NIC 1420 may be capable of performing one or more of the functions of the compute circuitry 1402 described herein. Additionally or alternatively, in such examples, the local memory of the NIC 1420 may be integrated into one or more components of the client compute node at the board level, socket level, chip level, and/or other levels.

Additionally, in some examples, a compute node 1400 may include one or more peripheral devices 1414. Such peripheral devices 1414 may include any type of peripheral device found in a compute device or server such as audio input devices, a display, other input/output devices, interface devices, and/or other peripheral devices, depending on the particular type of the compute node 1400. In further examples, the compute node 1400 may be embodied by a respective edge compute node in an edge computing system (e.g., client compute node 1302, edge gateway node 1312, edge aggregation node 1322) or like forms of appliances, computers, subsystems, circuitry, or other components.

In a more detailed example, FIG. 14B illustrates a block diagram of an example of components that may be present in an edge computing node 1450 for implementing the techniques (e.g., operations, processes, methods, and methodologies) described herein. The edge computing node 1450 may include any combinations of the components referenced above, and it may include any device usable with an edge communication network or a combination of such networks. The components may be implemented as ICs, portions thereof, discrete electronic devices, or other modules, logic, hardware, software, firmware, or a combination thereof adapted in the edge computing node 1450, or as components otherwise incorporated within a chassis of a larger system. Further, to support the security examples provided herein, a hardware RoT (e.g., provided according to a DICE architecture) may be implemented in a IP block of the edge computing node 1450 such that any IP Block may boot into a mode where a RoT identity may be generated that may attest its identity and its current booted firmware to another IP Block or to an external entity.

The edge computing node 1450 may include processing circuitry in the form of a processor 1452, which may be a microprocessor, a multi-core processor, a multithreaded processor, an ultra-low voltage processor, an embedded processor, or other known processing elements. The processor 1452 may be a part of a system on a chip (SoC) in which the processor 1452 and other components are formed into a single integrated circuit, or a single package, such as the Edison™ or Galileo™ SoC boards from Intel Corporation, Santa Clara, California. As an example, the processor 1452 may include an Intel® Architecture Core™ based processor, such as a Quark™, an Atom™, a Xeon™ an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. Or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc.

The processor 1452 may communicate with a system memory 1454 over an interconnect 1456 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1458 may also couple to the processor 1452 via the interconnect 1456. In an example, the storage 1458 may be implemented via a solid-state disk drive (SSDD). Other devices that may be used for the storage 1458 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magneto-resistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1458 may be on-die memory or registers associated with the processor 1452. However, in some examples, the storage 1458 may be implemented using a micro hard disk drive (HDD). Further, any number of new technologies may be used for the storage 1458 in addition to, or instead of, the technologies described, such resistance change memories, phase change memories, holographic memories, or chemical memories, among others.

The components may communicate over the interconnect 1456. The interconnect 1456 may include any number of technologies, including industry standard architecture (ISA), extended ISA (EISA), peripheral component interconnect (PCI), peripheral component interconnect extended (PCI-X), PCI express (PCIe), NVLink, or any number of other technologies. The interconnect 1456 may be a proprietary bus, for example, used in an SoC based system. Other bus systems may be included, such as an I2C interface, an SPI interface, point to point interfaces, and a power bus, among others.

The interconnect 1456 may couple the processor 1452 to a transceiver 1466, for communications with the connected edge devices 1462. The transceiver 1466 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1462. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1466 (or multiple transceivers) may communicate using multiple standards or radios for communications at a different range. For example, the edge computing node 1450 may communicate with close devices, e.g., within about 10 meters, using a local transceiver based on BLE, or another low power radio, to save power. More distant connected edge devices 1462, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee.

A wireless network transceiver 1466 (e.g., a radio transceiver) may be included to communicate with devices or services in the edge cloud 1490 via local or wide area network protocols. The wireless network transceiver 1466 may be an LPWA transceiver that follows the IEEE 802.15.4, or IEEE 802.15.4g standards, among others. The edge computing node 1450 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1466, as described herein. For example, the transceiver 1466 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1466 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1468 may be included to provide a wired communication to nodes of the edge cloud 1490 or to other devices, such as the connected edge devices 1462 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1468 may be included to enable connecting to a second network, for example, a first NIC 1468 providing communications to the cloud over Ethernet, and a second NIC 1468 providing communications to other devices over another type of network.

Given the variety of types of applicable communications from the device to another component or network, applicable communications circuitry used by the device may include or be embodied by any one or more of components such as circuitry 1464, transceiver 1466, NIC 1468, or interface 1470. Accordingly, in various examples, applicable means for communicating (e.g., receiving, transmitting, etc.) may be embodied by such communications circuitry.

The edge computing node 1450 may include or be coupled to acceleration circuitry 1464, which may be embodied by one or more AI accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 1456 may couple the processor 1452 to a sensor hub or external interface 1470 that is used to connect additional devices or subsystems. The devices may include sensors 1472, such as accelerometers, level sensors, flow sensors, optical light sensors, camera sensors, temperature sensors, a global positioning system (GPS) sensors, pressure sensors, barometric pressure sensors, and the like. The hub or interface 1470 further may be used to connect the edge computing node 1450 to actuators 1474, such as power switches, valve actuators, an audible sound generator, a visual warning device, and the like.

In some optional examples, various input/output (I/O) devices may be present within or connected to, the edge computing node 1450. For example, a display or other output device 1484 may be included to show information, such as sensor readings or actuator position. An input device 1486, such as a touch screen or keypad may be included to accept input. An output device 1484 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1450.

A battery 1476 may power the edge computing node 1450, although, in examples in which the edge computing node 1450 is mounted in a fixed location, it may have a power supply coupled to an electrical grid. The battery 1476 may be a lithium ion battery, or a metal-air battery, such as a zinc-air battery, an aluminum-air battery, a lithium-air battery, and the like.

A battery monitor/charger 1478 may be included in the edge computing node 1450 to track the state of charge (SoCh) of the battery 1476. The battery monitor/charger 1478 may be used to monitor other parameters of the battery 1476 to provide failure predictions, such as the state of health (SoH) and the state of function (SoF) of the battery 1476. The battery monitor/charger 1478 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1478 may communicate the information on the battery 1476 to the processor 1452 over the interconnect 1456. The battery monitor/charger 1478 may also include an analog-to-digital (ADC) converter that enables the processor 1452 to directly monitor the voltage of the battery 1476 or the current flow from the battery 1476. The battery parameters may be used to determine actions that the edge computing node 1450 may perform, such as transmission frequency, mesh network operation, sensing frequency, and the like.

A power block 1480, or other power supply coupled to a grid, may be coupled with the battery monitor/charger 1478 to charge the battery 1476. In some examples, the power block 1480 may be replaced with a wireless power receiver to obtain the power wirelessly, for example, through a loop antenna in the edge computing node 1450. A wireless battery charging circuit, such as an LTC4020 chip from Linear Technologies of Milpitas, California, among others, may be included in the battery monitor/charger 1478. The specific charging circuits may be selected based on the size of the battery 1476, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1458 may include instructions 1482 in the form of software, firmware, or hardware commands to implement the techniques described herein. Although such instructions 1482 are shown as code blocks included in the memory 1454 and the storage 1458, it may be understood that any of the code blocks may be replaced with hardwired circuits, for example, built into an application specific integrated circuit (ASIC).

In an example, the instructions 1482 provided via the memory 1454, the storage 1458, or the processor 1452 may be embodied as a non-transitory, machine-readable medium 1460 including code to direct the processor 1452 to perform electronic operations in the edge computing node 1450. The processor 1452 may access the non-transitory, machine-readable medium 1460 over the interconnect 1456. For instance, the non-transitory, machine-readable medium 1460 may be embodied by devices described for the storage 1458 or may include specific storage units such as optical disks, flash drives, or any number of other hardware devices. The non-transitory, machine-readable medium 1460 may include instructions to direct the processor 1452 to perform a specific sequence or flow of actions, for example, as described with respect to the flowchart(s) and block diagram(s) of operations and functionality depicted above. As used in, the terms “machine-readable medium” and “computer-readable medium” are interchangeable.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The block diagrams of FIGS. 14A and 14B are intended to depict a high-level view of components of a device, subsystem, or arrangement of an edge computing node. However, it will be understood that some of the components shown may be omitted, additional components may be present, and a different arrangement of the components shown may occur in other implementations.

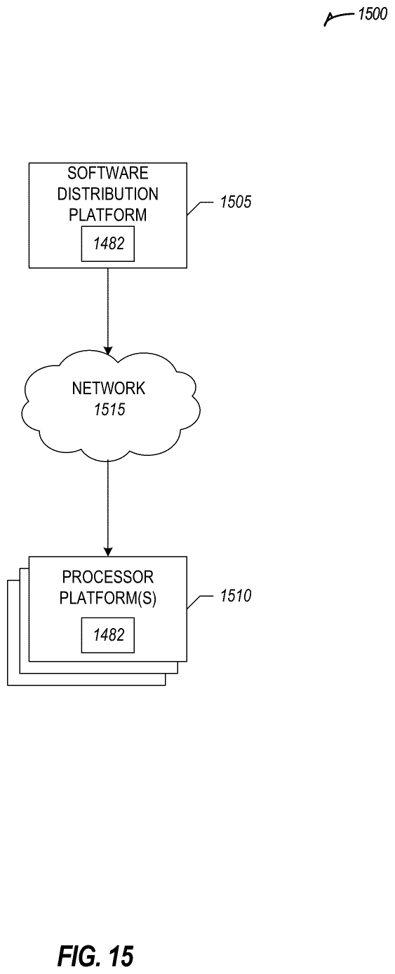

FIG. 15 illustrates an example software distribution platform 1505 to distribute software, such as the example computer readable instructions 1482 of FIG. 14B, to one or more devices, such as example processor platform(s) 1510 and/or other example connected edge devices or systems discussed herein. The example software distribution platform 1505 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1505). Example connected edge devices may operate in commercial and/or home automation environments. In some examples, a third party is a developer, a seller, and/or a licensor of software such as the example computer readable instructions 1482 of FIG. 14B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 15, the software distribution platform 1505 includes one or more servers and one or more storage devices that store the computer readable instructions 1482. The one or more servers of the example software distribution platform 1505 are in communication with a network 1515, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1482 from the software distribution platform 1505. For example, the software, which may correspond to example computer readable instructions, may be downloaded to the example processor platform(s), which is/are to execute the computer readable instructions 1482. In some examples, one or more servers of the software distribution platform 1505 are communicatively connected to one or more security domains and/or security devices through which requests and transmissions of the example computer readable instructions 1482 must pass. In some examples, one or more servers of the software distribution platform 1505 periodically offer, transmit, and/or force updates to the software (e.g., the example computer readable instructions 1482 of FIG. 14B) to ensure improvements, patches, updates, etc. are distributed and applied to the software at the end user devices.

In the illustrated example of FIG. 15, the computer readable instructions 1482 are stored on storage devices of the software distribution platform 1505 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1482 stored in the software distribution platform 1505 are in a first format when transmitted to the example processor platform(s) 1510. In some examples, the first format is an executable binary in which particular types of the processor platform(s) 1510 can execute. However, in some examples, the first format is uncompiled code that uses one or more preparation tasks to transform the first format to a second format to enable execution on the example processor platform(s) 1510. For instance, the receiving processor platform(s) 1500 may need to compile the computer readable instructions 1482 in the first format to generate executable code in a second format that is capable of being executed on the processor platform(s) 1510. In still other examples, the first format is interpreted code that, upon reaching the processor platform(s) 1510, is interpreted by an interpreter to facilitate execution of instructions.

What is claimed is:

1. A method for analyzing a state of a 5G network, the method comprising:
obtaining fingerprint reference data of a network state of the 5G network, based on radio communications between a virtualized radio access network (vRAN) node and at least one device wirelessly connected to the vRAN node, wherein the device produces the fingerprint reference data from measurements of operational parameters used in the radio communications;
comparing the fingerprint reference data to subsequent fingerprint data of the network state between the vRAN node and the at least one device to detect a changed network condition; and
performing an action at the vRAN node to modify or disable a component of the 5G network, in response to detection of the changed network condition.

2. The method of claim 1, wherein the fingerprint reference data and the subsequent fingerprint data are based on in-phase and quadrature (IQ) data captured from a reference signal, and wherein the reference signal is transmitted from the at least one device to the vRAN node.

3. The method of claim 2, wherein the reference signal is an uplink sounding reference signal (SRS), and wherein the IQ data includes data captured from respective antennas of the vRAN node.

4. The method of claim 1, wherein the comparing of the fingerprint reference data to the subsequent fingerprint data includes comparing values associated with at least one of: a frequency response associated with channel impulse responses; a signal-to-noise ratio; a Reference Signal Received Power (RSRP) value; or a Reference Signal Received Quality (RSRQ) value.

5. The method of claim 1, wherein the comparing of the fingerprint reference data to the subsequent fingerprint data includes comparison of a measured value to a threshold value.

6. The method of claim 5, wherein the threshold value is determined based on use of a trained model, and wherein the action at the vRAN node is determined based on use of the trained model.

7. The method of claim 5, wherein the threshold value is based on signal measurements of at least one of: amplitude, noise level, or power level.

8. The method of claim 1, wherein obtaining the fingerprint reference data includes capturing the fingerprint reference data in response to starting network operations at the vRAN node.

9. The method of claim 1, wherein the action at the vRAN node to modify or disable the component of the 5G network includes to perform at least one of:
cause an adjustment of power at a distributed unit (DU) of the vRAN node;
cause an adjustment of power at a user equipment (UE) wirelessly connected to the vRAN node;
change a Modulation and Coding Scheme (MCS) level;
change a time division duplex (TDD) pattern of the vRAN node;
change a compression rate of a radio unit of the vRAN node; or
disable at least one antenna of the vRAN node.

10. The method of claim 1, wherein the vRAN node is an Integrated Access Backhaul (JAB) Node or IAB Donor Node.

11. A device, comprising:
processing circuitry; and
a memory device including instructions embodied thereon, wherein the instructions, which when executed by the processing circuitry, configure the processing circuitry to perform operations that:
obtain fingerprint reference data of a network state of a 5G network, based on radio communications between a virtualized radio access network (vRAN) node and at least one fingerprint reference unit (FRU) circuitry wirelessly connected to the vRAN node, wherein the FRU circuitry produces the fingerprint reference data from measurements of operational parameters used in the radio communications;
compare the fingerprint reference data to subsequent fingerprint data of the network state between the vRAN node and the at least one FRU device to detect a changed network condition; and
cause an action to be performed at the vRAN node to modify or disable a component of the 5G network, in response to detection of the changed network condition.

12. The device of claim 11, wherein the fingerprint reference data and the subsequent fingerprint data are based on in-phase and quadrature (IQ) data captured from a reference signal, and wherein the reference signal is transmitted from the at least one FRU circuitry to the vRAN node.

13. The device of claim 12, wherein the reference signal is an uplink sounding reference signal (SRS), and wherein the IQ data includes data captured from respective antennas of the vRAN node.

14. The device of claim 11, wherein to compare the fingerprint reference data to the subsequent fingerprint data includes to compare values associated with at least one of: a frequency response associated with channel impulse responses; a signal-to-noise ratio; a Reference Signal Received Power (RSRP) value; or a Reference Signal Received Quality (RSRQ) value.

15. The device of claim 11, wherein to compare the fingerprint reference data to the subsequent fingerprint data includes to compare a measured value to a threshold value.

16. The device of claim 15, wherein the threshold value is determined based on use of a trained model, and wherein the action at the vRAN node is determined based on use of the trained model.

17. The device of claim 15, wherein the threshold value is based on signal measurements of at least one of: amplitude, noise level, or power level.

18. The device of claim 11, wherein to obtain the fingerprint reference data includes to capture the fingerprint reference data in response to starting network operations at the vRAN node.

19. The device of claim 11, wherein the action at the vRAN node to modify or disable the component of the 5G network includes to perform at least one of:
cause an adjustment of power at a distributed unit (DU) of the vRAN node;
cause an adjustment of power at a user equipment (UE) wirelessly connected to the vRAN node;
change a Modulation and Coding Scheme (MCS) level;
change a time division duplex (TDD) pattern of the vRAN node;
change a compression rate of a radio unit of the vRAN node; or
disable at least one antenna of the vRAN node.

20. The device of claim 11, wherein the vRAN node is an Integrated Access Backhaul (JAB) Node or IAB Donor Node.
